(19) United States
(12) Patent Application Publication
(10) Pub. No.: US 2023/0133767 A1
(43) Pub. Date: May 4, 2023

(54) LIDAR DEVICE AND METHOD FOR OPERATING SAME

(71) Applicant: SOS LAB Co., Ltd., Gwangju (KR)

(72) Inventors: Jong Kyu JUNG, Yongin-si (KR); Jaewon SEO, Suwon-si (KR); Seongyeol PARK, Hwaseong-si (KR)

(21) Appl. No.: 17/981,124

(22) Filed: Nov. 4, 2022

(30) Foreign Application Priority Data
Nov. 4, 2021 (KR) 10-2021-0150202

(51) Int. Cl. G01S 17/08; G01S 7/481; G01S 7/493; G01S 7/487

(52) U.S. Cl. CPC G01S 17/08; G01S 7/4817; G01S 7/493; G01S 7/4876

(57) ABSTRACT

Provided is a LiDAR (Light Detecting and Ranging) device for measuring distance using a laser, the LiDAR device including: a laser emitter configured to output the laser; a scanner configured to rotate around an axis of rotation, and be located at a reference measurement position and a scan position; a detector configured to detect the laser; and a controller configured to control the laser emitter and the detector, wherein the controller includes: a laser output controller configured to generate a trigger signal for controlling the laser emitter; and a detector controller configured to process a signal acquired from the detector and control the detector, wherein the detector controller includes: a correction signal calculator configured to calculate a correction signal to control a voltage applied to the detector; a distance offset calculator configured to calculate a distance offset; and a distance calculator configured to calculate a distance from an object.

### CROSS REFERENCE TO RELATED APPLICATION

The present application claims priority to Korean Patent Application No. 10-2021-0150202, filed Nov. 4, 2021, the entire contents of which is incorporated herein for all purposes by this reference.

### BACKGROUND OF THE INVENTION

### Field of the Invention

The present disclosure relates to a LiDAR device for acquiring distance information of an object by using a laser, and a method for operating the LiDAR device. More specifically, the present disclosure relates to a LiDAR device capable of reference measurement, and a method for operating a LiDAR device capable of compensation for a detector by using reference measurement and compensation for a signal.

### Description of the Related Art

A light detecting and ranging (LiDAR) device is a device for detecting a distance to an object by using a laser. In addition, the LiDAR device is a device capable of acquiring location information about things that are present nearby, by generating a point cloud using a laser. In addition, research on weather observation, 3D mapping, autonomous vehicles, autonomous drones, and unmanned robot sensors using LiDAR devices has been widely conducted.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a LiDAR device for calculating a distance by using reference measurement.

In addition, the present disclosure is directed to providing a method for operating the LiDAR device for calculating a distance by using reference measurement.

Technical problems to be solved by the present disclosure are not limited to the aforementioned technical problems and other technical problems which are not mentioned will be clearly understood by those skilled in the art from the present specification and the accompanying drawings.

According to an embodiment of the present disclosure, a LiDAR (Light Detecting and Ranging) device for measuring distance using a laser comprises: a laser emitter configured to output the laser; a scanner configured to rotate around an axis of rotation, and be located at a reference measurement position and a scan position; a detector configured to detect the laser; and a controller configured to control the laser emitter and the detector, wherein the controller comprises: a laser output controller configured to generate a trigger signal for controlling the laser emitter; and a detector controller configured to process a signal acquired from the detector and control the detector, wherein the detector controller comprises: a correction signal calculator configured to calculate a correction signal to control a voltage applied to the detector; a distance offset calculator configured to calculate a distance offset; and a distance calculator configured to calculate a distance from an object; wherein the correction signal calculator is configured to calculate the correction signal based on a first detecting signal acquired from the detector and outputted from the laser emitter and a reference signal when the scanner locates on the reference measurement position, wherein the distance offset calculator is configured to calculate offset information based on the first detecting signal acquired from the detector and outputted from the laser emitter and reference information when the scanner locates on the reference measurement position, wherein the distance calculator is configured to calculate the distance from the object based on a second detecting signal acquired in the detector and output from the laser emitter and the offset information when the scanner locates on the scan position.

According to an embodiment of the present disclosure, a method for operating LiDAR device for measuring distance using the laser comprises: positioning a scanner in a first reference measurement position; acquiring a first detecting signal for an outputted laser when the scanner is located on the first reference measurement position; acquiring a first compensation signal and first offset information based on the first detecting signal; changing a voltage applied to the detector to a first voltage based on the first compensation signal; positioning the scanner in a first scan position; acquiring a second detecting signal for the outputted laser when the scanner is located on the first scan position; acquiring first distance information based on first offset information and the second detecting signal; positioning the scanner in a second reference measurement position; acquiring a third detecting signal for the outputted laser when the scanner is located on the second reference measurement position; acquiring second offset information and a second compensation signal based on the third detecting signal; changing the voltage applied to the detector to a second voltage based on the second compensation signal; positioning the scanner in the second scan position; acquiring a fourth detecting signal for the outputted laser when the scanner is located on the second scan position; and acquiring the second distance information based on the fourth detecting signal and the second offset information.

According to an embodiment of the present disclosure, a LiDAR device comprises: a housing including an outer cover and a window; a laser emitter located in the housing, and configured to output a laser; a detector located in the housing, and configured to detect the laser; a scanner located in the housing, and configured to rotate around an axis of rotation in order to change a flight path of the laser output from the laser emitter; and a fixed mirror located in the housing, and configured to reflect the laser output from the laser emitter and reflected from the scanner when the scanner is in a first position, wherein when viewed from the top of the LiDAR device, the window may be formed extending from a first window end to a second window end, and when viewed from the top of the LiDAR device, the fixed mirror may be formed extending from a first mirror end to a second mirror end, and when viewed from the top of the LiDAR device, a first virtual line connecting the axis of rotation and the first window end and a second virtual line connecting the axis of rotation and the second window end may form a first angle in the direction of the window, and when viewed from the top of the LiDAR device, a third virtual line connecting the axis of rotation and the first mirror end and a fourth virtual line connecting the axis of rotation and the second mirror end may form a second angle in the direction of the fixed mirror, and the first angle may be wider than the second angle.

According to an embodiment of the present disclosure, a LiDAR device comprises: a housing including an outer cover and a window; a laser emitter located in the housing, and configured to output a laser; a detector located in the housing, and configured to detect the laser; a scanner located in the housing, and configured to rotate around an axis of rotation in order to change a flight path of the laser output from the laser emitter; and a fixed mirror located in the housing, and configured to reflect the laser output from the laser emitter and reflected from the scanner when the scanner is in a first position, wherein the scanner may include a reflective surface for changing the flight path of the laser output from the laser emitter, and the reflective surface may be placed at a first predetermined angle with respect to the axis of rotation, and the fixed mirror may be placed at a second predetermined angle with respect to the axis of rotation, and the second predetermined angle may be narrower than the first predetermined angle.

According to an embodiment of the present disclosure, a LiDAR device includes: a housing including an outer cover and a window; a laser emitter located in the housing, and configured to output a laser; a detector located in the housing, and configured to detect the laser; a scanner located in the housing, and configured to rotate around an axis of rotation in order to change a flight path of the laser output from the laser emitter; a fixed mirror located in the housing, and configured to reflect the laser output from the laser emitter and reflected from the scanner when the scanner is in a first position, wherein when viewed from the top of the LiDAR device, a distance between the laser emitter and the fixed mirror may be shorter than a distance between the detector and the fixed mirror, and when viewed from the side of the LiDAR device and when the scanner is in the first position, a distance between the laser emitter and a reflective surface may be longer than a distance between the detector and the reflective surface, and when a position of the scanner resulting from rotation by 180 degrees from the first position is referred to as a second position and when the scanner is in the second position, the laser output from the laser emitter may be reflected from the scanner and may pass through a first part of the window, and a vertical location of the fixed mirror may be different from a vertical location of the first part of the window.

However, the solving means of the problems of the present disclosure are not limited to the aforementioned solving means and other solving means which are not mentioned will be clearly understood by those skilled in the art from the present specification and the accompanying drawings.

According to an embodiment of the present disclosure, a LiDAR device for calculating a distance by using reference measurement can be provided.

According to another embodiment of the present disclosure, a LiDAR device for calculating a distance by using reference measurement can be provided.

The effects of the present disclosure are not limited to the aforementioned effects and other effects which are not mentioned will be clearly understood by those skilled in the art from the present specification and the accompanying drawings.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating a LiDAR device according to an embodiment;

FIG. 2 is a diagram illustrating a LiDAR device according to an embodiment;

FIG. 3 is a diagram illustrating a LiDAR device according to an embodiment;

FIG. 4 is a diagram illustrating a LiDAR device according to an embodiment;

FIG. 5 is a diagram illustrating an arrangement relationship between elements included in a LiDAR device, an emission direction and a scan point of a laser according to an embodiment;

FIG. 6 is a diagram illustrating an arrangement relationship between elements included in a LiDAR device, an emission direction and a scan point of a laser according to another embodiment;

FIG. 7 is a diagram illustrating an arrangement relationship between elements included in a LiDAR device, an emission direction and a scan point of a laser according to yet another embodiment;

FIG. 8 is a schematic perspective view of a LiDAR device according to an embodiment;

FIG. 9 is a top view of a LiDAR device according to an embodiment;

FIGS. 10 and 11 are side views of a LiDAR device according to an embodiment;

FIGS. 12 and 13 are front views of a LiDAR device according to an embodiment;

FIGS. 14 and 15 are rear views of a LiDAR device according to an embodiment;

FIG. 16 is a schematic perspective view of a LiDAR device according to an embodiment;

FIG. 17 is a side view of a LiDAR device according to an embodiment;

FIG. 18 is a front view of a LiDAR device according to an embodiment;

FIG. 19 is a top view of a LiDAR device according to an embodiment;

FIGS. 20 and 21 are side views of a LiDAR device according to an embodiment;

FIG. 22 is a diagram illustrating a LiDAR device according to an embodiment;

FIG. 23 is a diagram illustrating a correlation between a received signal gain and a measurement distance;

FIG. 24 is a flowchart illustrating a method of calculating a compensation signal according to an embodiment;

FIG. 25 is a diagram illustrating a compensation signal method according to an embodiment;

FIGS. 26A and 26B are diagrams illustrating a correlation between a laser output trigger signal and an actual laser output time point;

FIGS. 27A though 27C are diagrams illustrating the operation of a distance offset calculator according to an embodiment;

FIGS. 28A through 28C are diagrams illustrating the operation of a distance offset calculator according to an embodiment;

FIGS. 29A through 29C are diagrams illustrating the operation of a distance offset calculator according to an embodiment;

FIGS. 30 and 31 are flowcharts illustrating a method for operating a LiDAR device according to an embodiment; and

FIGS. 32A and 32B are diagrams illustrating comparison between measurement results according to an embodiment.

### DETAILED DESCRIPTION OF THE INVENTION

Embodiments described in the present specification are for clearly describing the idea of the present disclosure to those skilled in the art to which the present disclosure belongs, so the present disclosure is not limited to the embodiments described in the present specification and the scope of the present disclosure should be construed as including modifications or variations that are within the idea of the present disclosure.

As the terms used in the present specification, general terms currently widely used are used considering functions in the present disclosure. However, the terms may vary according to the intentions of those skilled in the art, precedents, or the emergence of new technology. However, unlike this, when a particular term is used defined as having an optional meaning, the meaning of the term will be described. Thus, the terms used in the present specification should be construed based on the actual meanings of the terms and details throughout the present specification rather than simply the names of the terms.

The drawings accompanying the present specification are for easily describing the present disclosure, and the shapes shown in the drawings may be exaggerated to help the understanding of the present disclosure, so the present disclosure is not limited by the drawings.

In the present specification, if it is decided that a detailed description of known configuration or function related to the present disclosure makes the subject matter of the present disclosure unclear, the detailed description is omitted.

According to an embodiment of the present disclosure, a LiDAR (Light Detecting and Ranging) device for measuring distance using a laser comprises: a laser emitter configured to output the laser; a scanner configured to rotate around an axis of rotation, and be located at a reference measurement position and a scan position; a detector configured to detect the laser; and a controller configured to control the laser emitter and the detector, wherein the controller comprises: a laser output controller configured to generate a trigger signal for controlling the laser emitter; and a detector controller configured to process a signal acquired from the detector and control the detector, wherein the detector controller comprises: a correction signal calculator configured to calculate a correction signal to control a voltage applied to the detector; a distance offset calculator configured to calculate a distance offset; and a distance calculator configured to calculate a distance from an object; wherein the correction signal calculator is configured to calculate the correction signal based on a first detecting signal acquired from the detector and outputted from the laser emitter and a reference signal when the scanner locates on the reference measurement position, wherein the distance offset calculator is configured to calculate offset information based on the first detecting signal acquired from the detector and outputted from the laser emitter and reference information when the scanner locates on the reference measurement position, wherein the distance calculator is configured to calculate the distance from the object based on a second detecting signal acquired in the detector and output from the laser emitter and the offset information when the scanner locates on the scan position.

Herein, the correction signal calculator may be configured to calculate the correction signal based on a difference between a width of the first detecting signal and a width of the reference signal acquired from the detector.

Herein, the correction signal calculator may be configured to calculate the correction signal based on a half of the difference between the width of the first detecting signal and the width of the reference signal acquired from the detector.

Herein, the distance offset calculator may be configured to calculate the offset information based on a reference time interval which the reference information comprises and a time point of detection of the first detecting signal acquired from the detector.

Herein, the time point of detection of the first detecting signal acquired from the detector may be obtained using a preset threshold and the signal acquired from the detector.

Herein, the reference time interval may be a pre-stored time interval based on a reference light path.

Herein, the offset information may include at least one of the offset distance and the offset time.

Herein, the distance calculator may be configured to calculate the distance from the object based on the offset information and the time point of detection of the second detecting signal and the time point of generation of the trigger signal.

Herein, the distance calculator may be configured to calculate the distance from the object by correcting the time interval between the time point of detection of the second detecting signal and the time point of generation of the trigger signal using the offset information.

According to an embodiment of the present disclosure, a method for operating LiDAR device for measuring distance using the laser comprises: positioning a scanner in a first reference measurement position; acquiring a first detecting signal for an outputted laser when the scanner is located on the first reference measurement position; acquiring a first compensation signal and first offset information based on the first detecting signal; changing a voltage applied to the detector to a first voltage based on the first compensation signal; positioning the scanner in a first scan position; acquiring a second detecting signal for the outputted laser when the scanner is located on the first scan position; acquiring first distance information based on first offset information and the second detecting signal; positioning the scanner in a second reference measurement position; acquiring a third detecting signal for the outputted laser when the scanner is located on the second reference measurement position; acquiring second offset information and a second compensation signal based on the third detecting signal; changing the voltage applied to the detector to a second voltage based on the second compensation signal; positioning the scanner in the second scan position; acquiring a fourth detecting signal for the outputted laser when the scanner is located on the second scan position; and acquiring the second distance information based on the fourth detecting signal and the second offset information.

Herein, the first reference measurement position may be identical to the second reference measurement position.

Herein, when the first scan position is identical to the second scan position and the first offset information is different from the second offset information, a time point of detection of the second detecting signal and a time point of detection of the fourth detecting signal may not be same.

Herein, the first compensation signal may be acquired based on a width of a pre-stored reference signal and a width of the first detecting signal, and the second compensation signal may be acquired based on the width of the pre-stored reference signal and a width of the third detecting signal.

Herein, the first compensation signal may be acquired based on a difference between the width of the pre-stored reference signal and the width of the first detecting signal, and the second compensation signal may be acquired based on a difference between the width of pre-stored reference signal and the width of the third detecting signal.

Herein, the first distance information may be acquired based on a difference between a width of a pre-stored reference signal and a width of the first detecting signal, the first offset information and the second detecting signal.

Herein, the second distance information may be acquired based on a difference between the width of the pre-stored reference signal and the width of the third detecting signal, the second offset information and the fourth detecting signal.

According to an embodiment of the present disclosure, a LiDAR device comprises: a housing including an outer cover and a window; a laser emitter located in the housing, and configured to output a laser; a detector located in the housing, and configured to detect the laser; a scanner located in the housing, and configured to rotate around an axis of rotation in order to change a flight path of the laser output from the laser emitter; and a fixed mirror located in the housing, and configured to reflect the laser output from the laser emitter and reflected from the scanner when the scanner is in a first position, wherein when viewed from the top of the LiDAR device, the window may be formed extending from a first window end to a second window end, and when viewed from the top of the LiDAR device, the fixed mirror may be formed extending from a first mirror end to a second mirror end, and when viewed from the top of the LiDAR device, a first virtual line connecting the axis of rotation and the first window end and a second virtual line connecting the axis of rotation and the second window end may form a first angle in the direction of the window, and when viewed from the top of the LiDAR device, a third virtual line connecting the axis of rotation and the first mirror end and a fourth virtual line connecting the axis of rotation and the second mirror end may form a second angle in the direction of the fixed mirror, and the first angle may be wider than the second angle.

Herein, the first angle may be equal to or wider than a 180 degree angle.

Herein, the second angle may be equal to or narrower than a 20 degree angle.

Herein, when viewed from the top of the LiDAR device, a region surrounded by the first virtual line, the second virtual line, and the window may be referred to as a first region, and when viewed from the top of the LiDAR device, a region surrounded by the third virtual line, the fourth virtual line, and the fixed mirror may be referred to as a second region. In this case, the fixed mirror and the window may be placed such that the first region and the second region do not overlap.

Herein, when viewed from the top of the LiDAR device, a size of a region in which the first region and the scanner overlap may be greater than a size of a region in which the second region and the scanner overlap.

Herein, when viewed from the top of the LiDAR device, the scanner may include a third region not overlapped by the first region and the second region.

Herein, a value obtained by adding the area of the first region, the area of the second region, and the area of the third region may be equal to the area of the scanner when viewed from the top of the LiDAR device.

Herein, the first position of the scanner may mean a position in a state in which the scanner is at a particular angle when the scanner rotates around the axis of rotation.

According to an embodiment of the present disclosure, a LiDAR device comprises: a housing including an outer cover and a window; a laser emitter located in the housing, and configured to output a laser; a detector located in the housing, and configured to detect the laser; a scanner located in the housing, and configured to rotate around an axis of rotation in order to change a flight path of the laser output from the laser emitter; and a fixed mirror located in the housing, and configured to reflect the laser output from the laser emitter and reflected from the scanner when the scanner is in a first position, wherein the scanner may include a reflective surface for changing the flight path of the laser output from the laser emitter, and the reflective surface may be placed at a first predetermined angle with respect to the axis of rotation, and the fixed mirror may be placed at a second predetermined angle with respect to the axis of rotation, and the second predetermined angle may be narrower than the first predetermined angle.

Herein, the first predetermined angle may be a 45 degree angle.

Herein, the second predetermined angle may be wider than a 0 degree angle, but may be narrower than a 45 degree angle.

Herein, when viewed from one side of the LiDAR device and when the scanner is in the first position, an angle formed by a lower part and an upper part of the scanner and the center of the fixed mirror is a first angle, and the second predetermined angle may be narrower than the half of the first angle.

According to an embodiment of the present disclosure, a LiDAR device includes: a housing including an outer cover and a window; a laser emitter located in the housing, and configured to output a laser; a detector located in the housing, and configured to detect the laser; a scanner located in the housing, and configured to rotate around an axis of rotation in order to change a flight path of the laser output from the laser emitter; a fixed mirror located in the housing, and configured to reflect the laser output from the laser emitter and reflected from the scanner when the scanner is in a first position, wherein when viewed from the top of the LiDAR device, a distance between the laser emitter and the fixed mirror may be shorter than a distance between the detector and the fixed mirror, and when viewed from the side of the LiDAR device and when the scanner is in the first position, a distance between the laser emitter and a reflective surface may be longer than a distance between the detector and the reflective surface, and when a position of the scanner resulting from rotation by 180 degrees from the first position is referred to as a second position and when the scanner is in the second position, the laser output from the laser emitter may be reflected from the scanner and may pass through a first part of the window, and a vertical location of the fixed mirror may be different from a vertical location of the first part of the window.

Herein, the scanner may include the reflective surface for changing the flight path of the laser output from the laser emitter, and a difference between the vertical location of the fixed mirror and the vertical location of the first part of the window may be smaller than a diameter value of the reflective surface.

Herein, the vertical location of the fixed mirror may be defined on the basis of the center of the fixed mirror.

Herein, the vertical location of the first part of the window may be defined on the basis of a point at which the first part and the center of the laser passing through the first part meet.

### 1. Summary of a LiDAR Device and Terms

A LiDAR device is a device for detecting a distance to an object and the location of the object by using a laser. For example, the LiDAR device may output a laser, and when the output laser is reflected from the object, the LiDAR device receives the reflected laser to measure the distance between the object and the LiDAR device and the location of the object. Herein, the distance and the location of the object may be expressed through a coordinate system. For example, the distance and the location of the object may be expressed in a spherical coordinate system (R, θ, Ø). However, without being limited thereto, the distance and the location of the object may be expressed in a rectangular coordinate system (X, Y, Z) or a cylindrical coordinate system (R, ϵ, Z).

In addition, in order to measure the distance to the object, the LiDAR device may use the laser that is output from the LiDAR device and reflected from the object.

A LiDAR device according to an embodiment may use the time of flight (TOF) that it takes for a laser to be output and detected so as to measure a distance to an object. For example, the LiDAR device may measure the distance to the object by using the difference between a time value based on the time of output when the laser is output and a time value based on the time of detection when the laser is reflected from the object and detected.

In addition to the time of flight (TOF), a LiDAR device according to an embodiment may use a triangulation method, an interferometry method, or phase shift measurement in order to measure a distance to an object, but is not limited thereto.

### 2. Configuration of a LiDAR Device

Hereinafter, various embodiments of elements of a LiDAR device will be described in detail.

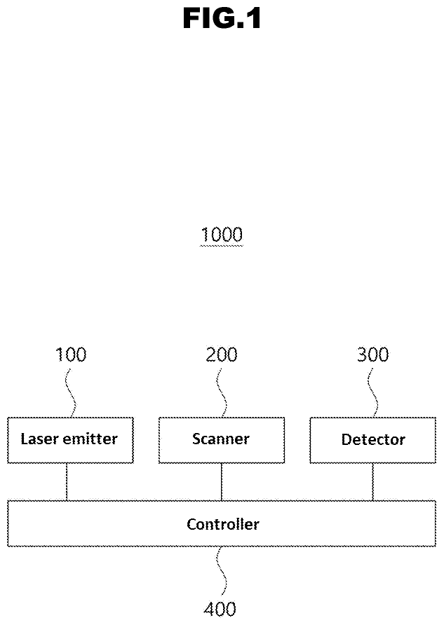

FIG. 1 is a diagram illustrating a LiDAR device according to an embodiment.

Referring to FIG. 1, a LiDAR device 1000 according to an embodiment may comprise a laser emitter 100.

Herein, a laser emitter 100 according to an embodiment may output a laser.

In addition, the laser emitter 100 may comprise one or more laser output elements. For example, the laser emitter 100 may include a single laser output element or a plurality of laser output elements. When the laser emitter 100 comprises a plurality of laser output elements, the plurality of laser output elements may constitute one array.

Furthermore, the laser emitter 100 may comprise a laser diode (LD), a solid-state laser, a high power laser, a light-emitting diode (LED), a vertical-cavity surface-emitting laser (VCSEL), or an external cavity diode laser (ECDL), but is not limited thereto.

In addition, the laser emitter 100 may output a laser with a predetermined wavelength. For example, the laser emitter 100 may output a laser with a wavelength of 905 nm or a laser with a wavelength of 1550 nm. Furthermore, for example, the laser emitter 100 may output a laser with a wavelength of 940 nm. Furthermore, for example, the laser emitter 100 may output a laser with a plurality of wavelengths ranging from 800 nm to 1000 nm. Furthermore, when the laser emitter 100 includes a plurality of laser output elements, some of the plurality of laser output elements may output lasers with a wavelength of 905 nm, and others may output lasers with a wavelength of 1550 nm.

Referring back to FIG. 1, a LiDAR device 1000 according to an embodiment may include a scanner 200.

Herein, a scanner 200 according to an embodiment may change the flight path of a laser. For example, the scanner 200 may change the flight path of a laser such that the laser emitted from the laser emitter 100 is toward a scan region. Furthermore, for example, the scanner 200 may change the flight path of the laser such that the laser reflected from an object located in the scan region is toward a detector.

In addition, a scanner 200 according to an embodiment may reflect a laser to change the flight path of the laser. For example, the scanner 200 may reflect a laser emitted from the laser emitter 100 to change the flight path of the laser such that the laser is toward a scan region. Furthermore, for example, the scanner 200 may change the flight path of the laser such that the laser reflected from an object located in the scan region is toward a detector.

In addition, a scanner 200 according to an embodiment may include various optical means to reflect a laser. For example, the scanner 200 may include a mirror, a resonance scanner, a MEMS mirror, a voice coil motor (VCM), a polygonal mirror, a rotating mirror, or a Galvano mirror, but is not limited thereto.

In addition, a scanner 200 according to an embodiment may refract a laser to change the flight path of the laser. For example, the scanner 200 may refract a laser emitted from the laser emitter 100 to change the flight path of the laser such that the laser is toward a scan region. Furthermore, for example, the scanner 200 may change the flight path of the laser such that the laser reflected from an object located in the scan region is toward a detector.

In addition, a scanner 200 according to an embodiment may include various optical means to refract a laser. For example, the scanner 200 may include a lens, a prism, a microlens, or a microfluidic lens, but is not limited thereto.

In addition, a scanner 200 according to an embodiment may change the phase of a laser to change the flight path of the laser. For example, the scanner 200 may change the phase of a laser emitted from the laser emitter 100 to change the flight path of the laser such that the laser is toward a scan region. Furthermore, for example, the scanner 200 may change the flight path of the laser such that the laser reflected from an object located in the scan region is toward a detector.

In addition, a scanner 200 according to an embodiment may include various optical means to change the phase of a laser. For example, the scanner 200 may include an optical phased array (OPA), a meta lens, or a meta surface, but is not limited thereto.

In addition, a scanner 200 according to an embodiment may include one or more optical means. Furthermore, for example, the scanner 200 may include a plurality of optical means.

Referring back to FIG. 1, a LiDAR device 100 according to an embodiment may include a detector 300.

Herein, a detector 300 according to an embodiment may detect a laser. For example, the detector may detect a laser reflected from an object located in a scan region.

In addition, a detector 300 according to an embodiment may receive a laser, and may generate an electrical signal on the basis of the received laser. For example, the detector 300 may receive a laser reflected from an object located in a scan region, and may generate an electrical signal on the basis of the received laser. Furthermore, for example, the detector 300 may receive a laser reflected from an object located in a scan region through the scanner 200, and may generate an electrical signal on the basis of the received laser.

In addition, a detector 300 according to an embodiment may detect a laser on the basis of an electrical signal generated. For example, the detector 300 may detect a laser by comparing a predetermined threshold with the magnitude of an electrical signal generated, but is not limited thereto.

In addition, a detector 300 according to an embodiment may include various sensor elements. For example, the detector 300 may include a PN photodiode, a photo-transistor, a PIN photodiode, an avalanche photodiode (APD), a single-photon avalanche diode (SPAD), silicon photomultipliers (SiPM), a complementary metal-oxide-semiconductor (CMOS), or a charge coupled device (CCD), but is not limited thereto.

In addition, a detector 300 according to an embodiment may include one or more sensor element. For example, the detector 300 may include a single sensor element or a plurality of sensor elements.

Referring back to FIG. 1, a LiDAR device 1000 according to an embodiment may include a controller 400.

Herein, a controller 400 according to an embodiment may control the operation of the laser emitter 100, the scanner 200, or the detector 300.

In addition, a controller 400 according to an embodiment may control the operation of the laser emitter 100.

For example, the controller 400 may control a time point of output of a laser output from the laser emitter 100. Furthermore, the controller 400 may control the power of a laser output from the laser emitter 100. Furthermore, the controller 400 may control the pulse width of a laser output from the laser emitter 100. Furthermore, the controller 400 may control the period (cycle) of a laser output from the laser emitter 100. Furthermore, when the laser emitter 100 comprises a plurality of laser output elements, the controller 400 may control the laser emitter 100 such that some of the plurality of laser output elements operate in a predetermined sequence. The controller 400 may control the plurality of laser output elements individually, or column by column or row by row.

In addition, a controller 400 according to an embodiment may control the operation of the scanner 200.

For example, the controller 400 may control the operating speed of the scanner 200. Specifically, when the scanner 200 includes a rotating mirror, the controller 400 may control the rotation speed of the rotating mirror. When the scanner 200 includes a MEMS mirror, the controller 400 may control the repetition period of the MEMS mirror. However, no limitation thereto is imposed.

In addition, for example, the controller 400 may control the degree of operation of the scanner 200. Specifically, when the scanner 200 includes a MEMS mirror, the controller 400 may control the angle of operation of the MEMS mirror, but is not limited thereto.

In addition, a controller 400 according to an embodiment may control the operation of the detector 300.

For example, the controller 400 may control the sensitivity of the detector 300. Specifically, the controller 400 may control the sensitivity of the detector 300 by adjusting a predetermined threshold, but is not limited thereto.

In addition, for example, the controller 400 may control the operation of the detector 300. Specifically, the controller 400 may control the on/off operation of the detector 300. When the detector 300 includes a plurality of sensor elements, the controller 400 may control the operation of the detector 300 such that some of the plurality of sensor elements operate. The controller 400 may control the plurality of sensor individually, column by column, or row by row.

In addition, a controller 400 according to an embodiment may determine a distance from the LiDAR device 1000 to an object located in a scan region, on the basis of a laser detected by the detector 300.

For example, the controller 400 may determine a distance to an object located in a scan region, on the basis of a time point of output of a laser from the laser emitter 100 and a time point of detection of the laser by the detector 300.

Specifically, the laser emitter 100 may output a laser, and the controller 400 may acquire a time point of output of the laser from the laser emitter 100. When the laser output from the laser emitter 100 is reflected from an object located in a scan region, the detector 300 may detect the laser reflected from the object, the controller 400 may acquire a time point of detection of the laser by the detector 300, and the controller 4000 may use the time point of output of the laser and the time point of detection of the laser to determine a distance to the object located in the scan region.

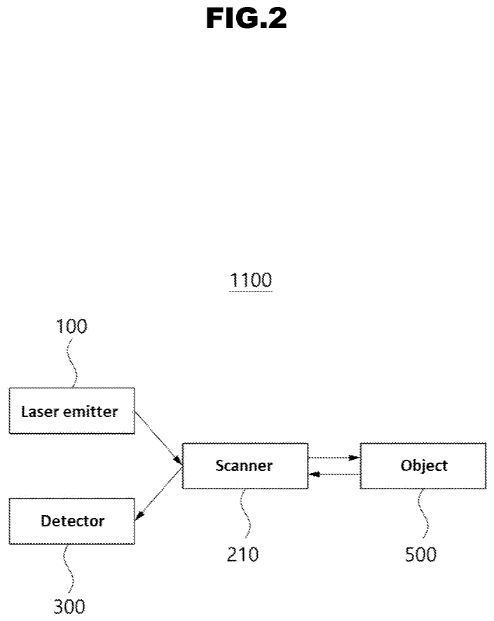

FIG. 2 is a diagram illustrating a LiDAR device according to an embodiment.

Referring to FIG. 2, a LiDAR device 1100 according to an embodiment may comprise a laser emitter 100, a scanner 210, and a detector 300.

Since the laser emitter 100 and the detector 300 have been described with reference to FIG. 1, a detailed description of the laser emitter 100 and the detector 300 will be omitted below.

A scanner 210 according to an embodiment may be an embodiment of the scanner 200. For example, the scanner 210 may reflect a laser output from the laser emitter 100 to change the flight path of the laser such that the laser is toward a scan region.

In addition, the scanner 210 may include a rotating mirror.

In addition, the LiDAR device 1100 may have an emission path that is a light path of a laser output from the laser emitter 1000. The laser may fly along the emission path toward specific point within the scan region. The laser may reach an object 500 located in the scan region. The laser may be reflected by an object 500 located in the scan region.

Specifically, a laser output from the laser emitter 100 may be acquired (received) by the scanner 210. Furthermore, the laser acquired (received) by the scanner 210 is reflected from the scanner 210 and the flight path of the laser may be changed such that the laser is toward a scan region. Furthermore, the laser reflected from the scanner 210 may reach the object 500.

In addition, the LiDAR device 1100 may have a light-receiving path that is a light path of laser reflected by the object 500. The reflected laser may fly along the light-receiving path toward the LiDAR device 1100. The reflected laser along the light-receiving path may be specifically toward the scanner 210 or the detector 300.

Specifically, a laser reflected from the object 500 may be acquired (received) by the scanner 210. Furthermore, the laser acquired (received) by the scanner 210 may be reflected from the scanner 210 and the flight path of the laser may be changed such that the laser is toward the detector 300. Furthermore, the laser reflected from the scanner 210 may reach the detector 300.

In addition, a part of the scanner 210 included in the emission path of the LiDAR device 1100 and a part of the scanner 210 included in the light-receiving path may be the same, may be different from each other, or may partially overlap each other, but are not limited thereto.

### 3. Various Embodiments of a LiDAR Device

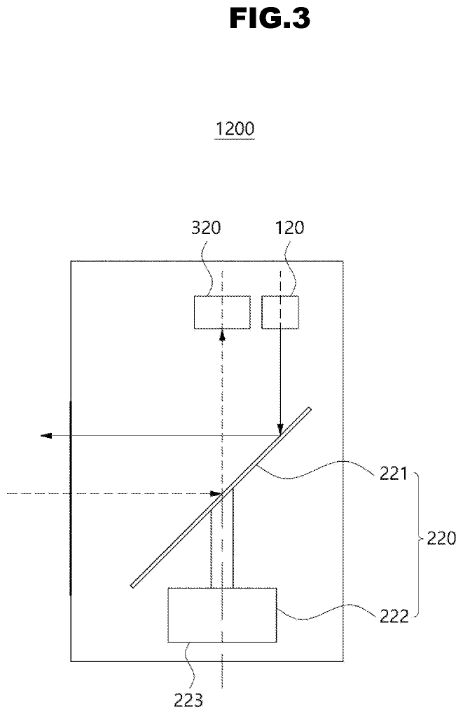

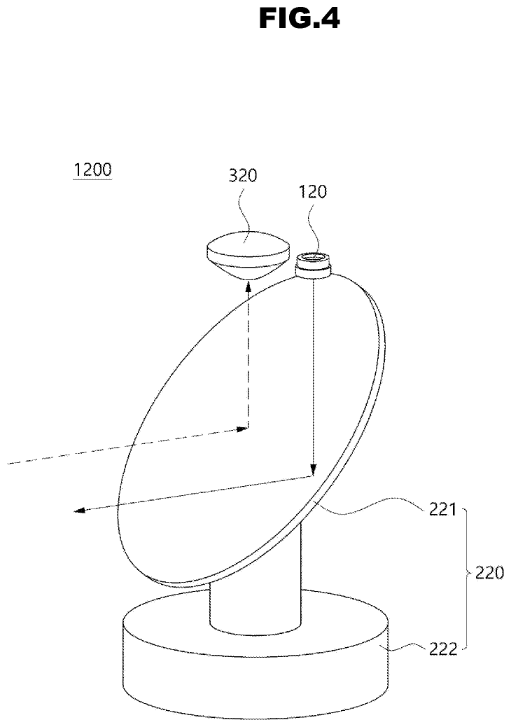

FIGS. 3 and 4 are diagrams illustrating a LiDAR device according to an embodiment.

Referring to FIGS. 3 and 4, a LiDAR device according to an embodiment may include a laser emitter 120, a scanner 220, and a detector 320.

Since the laser emitter 120 and the detector 320 have been described with reference to FIG. 1, a detailed description of the laser emitter 120 and the detector 320 will be omitted below.

A scanner 220 according to an embodiment may include a reflective surface 221 and a rotary motor 222.

Herein, a reflective surface 221 according to an embodiment may acquire (receive) and reflect a laser. For example, the reflective surface 221 may acquire a laser output from the laser emitter 120 and may reflect the laser toward a scan region. Furthermore, for example, the reflective surface 221 may acquire a laser reflected from an object and may reflect the laser toward the detector 320.

In addition, a reflective surface 221 according to an embodiment may be placed at a predetermined angle with respect to an axis 223 of rotation of the rotary motor 222. For example, the reflective surface 221 may be placed at a 45 degree angle with respect to the axis 223 of rotation of the rotary motor 222.

In addition, a reflective surface 221 according to an embodiment may change the flight path of a laser output from a laser emitter 120. For example, as shown in FIG. 3, the laser emitter 120 may be placed such that the flight path of the output laser goes in a vertical direction, and the reflective surface 221 may be placed at a 45 degree angle with respect to the axis 223 of rotation. In this case, the flight path may be changed such that the laser output from the laser emitter 120 and traveling in a vertical direction is reflected from the reflective surface 221 and travels in a horizontal direction.

In addition, a reflective surface 221 according to an embodiment may be rotated through the rotary motor 222. Specifically, the reflective surface 221 may rotate around the axis 223 of rotation of the rotary motor 222.

In addition, a reflective surface 221 according to an embodiment may change the flight path of a laser output from the laser emitter 120 into a different direction depending on a rotation angle. For example, when the reflective surface 221 is rotated at an angle as shown in FIG. 3, the flight path may be changed such that the laser output from the laser emitter 120 and traveling in a vertical direction is reflected from the reflective surface 221 and travels in a horizontal direction to the left. Conversely, although not shown in FIG. 3, when the reflective surface 221 is rotated by 180 degrees around the axis 223 of rotation from the state shown in FIG. 3, the flight path may be changed such that the laser output from the laser emitter 120 and traveling in a vertical direction is reflected from the reflective surface 221 and travels in a horizontal direction to the right.

Referring back to FIG. 3, a laser emitter 120 according to an embodiment may output a laser, and may be placed such that the output laser is incident on the reflective surface 221.

For example, as shown in FIG. 3, a laser emitter 120 according to an embodiment may be placed above the reflective surface 221.

In addition, for example, although not shown in FIG. 3, the laser emitter 120 may further include a fixed mirror. The fixed mirror may be placed above the reflective surface 221 and the laser emitter 120 may be placed to allow the output laser to be incident on the reflective surface 221.

In addition, the laser emitter 120 may be placed to be spaced apart from the axis 223 of rotation.

In addition, although not shown in FIG. 3, the laser emitter 120 may be placed to correspond to the axis 223 of rotation.

Referring back to FIG. 3, a detector 320 according to an embodiment may acquire a laser, and may be placed such that when a laser reflected from an object located in a scan region is reflected from the reflective surface 221, the detector 320 acquires the laser reflected from the reflective surface 221.

For example, as shown in FIG. 3, a detector 320 according to an embodiment may be placed above the reflective surface 221.

In addition, for example, although not shown in FIG. 3, the detector 320 may further include a fixed mirror. The fixed mirror may be placed above the reflective surface 221 and the detector 320 may be placed to allow a laser reflected from the reflective surface 221 to be incident on the detector 320.

In addition, the detector 320 may be placed to correspond to the axis 223 of rotation.

In addition, although not shown in FIG. 3, the detector 320 may be placed to be spaced apart from the axis 223 of rotation.

In addition, when the laser emitter 120 is placed to be spaced apart from the axis 223 of rotation, a location on which a laser output from the laser emitter 120 is incident in the reflective surface 221 may be changed as the reflective surface 221 rotates.

In addition, when the detector 320 is placed to correspond to the axis 223 of rotation and when a laser acquired by the detector 320 is reflected from the reflective surface 221, a location in the reflective surface 221 from which the laser is reflected may not be changed even when the reflective surface 221 rotates.

In addition, the LiDAR device 1200 may include the laser emitter 120 and the detector 320, and in the LiDAR device 1200, the detector 320 may be placed to correspond to the axis 223 of rotation in order to maximize light-receiving efficiency by making the center of a laser acquired by the detector 320 constant, and the laser emitter 120 may be placed to be spaced apart from the axis 223 of rotation so as not to interfere with the laser acquired by the detector 320.

### 3.1 Arrangement in and a Scan Point of a LiDAR Device According to an Embodiment

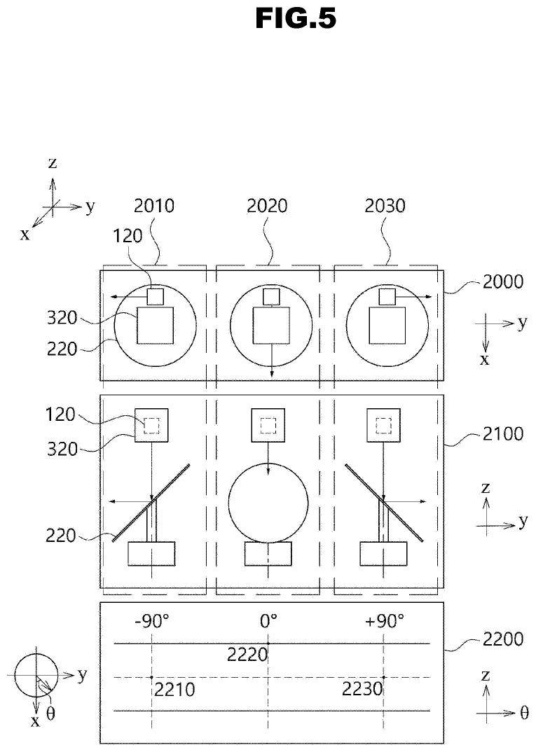

FIG. 5 is a diagram illustrating an arrangement relationship between elements included in a LiDAR device, an emission direction and a scan point of a laser according to an embodiment.

Before describing FIG. 5, terms may be defined for convenience of description. Directions, a scan point, and an origin of a LiDAR device may be defined.

In addition, in this chapter, directions may be defined using a coordinate system.

For example, with respect to a rectangular coordinate system (x, y, z), the +x direction is defined as the forward direction, the −x direction is defined as the backward direction, the +y direction is defined as the right direction, the −y direction is defined as the left direction, the +z direction is defined as the upward direction, and the −z direction is defined as the downward direction. This will be used to describe this chapter. Furthermore, the forward direction may correspond to the center of a plurality of lasers output from a LiDAR device.

In addition, in this chapter, a point generated by a laser emitted from a LiDAR device may be defined as a scan point, and the location of the scan point may be expressed using e. Herein, e may mean an angle between the +x axis and a line connecting the origin of the LiDAR device and the scan point, but is not limited thereto.

In addition, the origin of the LiDAR device is a virtual point for expressing the location of the scan point, and may be set randomly. For example, the origin of the LiDAR device may be set to correspond to the center of a reflective surface included in a scanner, but is not limited thereto.

Referring to FIG. 5, a LiDAR device according to an embodiment may comprise a laser emitter 120, a scanner 220, and a detector 320.

In addition, the scanner 220 may rotate around an axis of rotation.

Herein, the scanner 220 may rotate and may thus be in a first state 2010, a second state 2020, and a third state 2030.

In addition, referring to FIG. 5, it is shown that a top view 2000 and a front view 2100 in the first state 2010, the second state 2020, and the third state 2030.

Herein, referring to the top view 2000 and the front view 2100, an arrangement relationship between the laser emitter 120, the scanner 220, and the detector 320 included in the LiDAR device may be understood.

In addition, referring to the top view 2000, the laser emitter 120 may be placed behind the axis of rotation of the scanner 220. Furthermore, the detector 320 may be placed to correspond to the axis of rotation of the scanner 220.

In addition, referring to the front view 2100, the laser emitter 120 may be placed above the scanner 220. In addition, the detector 320 may be placed above the scanner 220.

Accordingly, the laser emitter 120 may be placed above the scanner 220 and may be placed behind the axis of rotation of the scanner 220. In addition, the detector 320 may be placed above the scanner 220 and may be placed to correspond to the axis of rotation of the scanner 220.

In addition, referring to the top view 2000 in the first state 2010, a laser output from the laser emitter 120 may be reflected by the scanner 220 and may be emitted in the left direction.

In addition, referring to the front view 2100 in the first state 2010, a laser output from the laser emitter 120 may be output downward, may be reflected from the scanner 220, and may be emitted in the left direction.

In addition, referring to the top view 2000 and the front view 2100 in the first state 2010, a laser output from the laser emitter 120 may be incident on a part spaced apart from the center of the scanner 220 when viewed from the top, and may be incident on a part corresponding to the center of the scanner 220 when viewed from the front.

In addition, in the first state 2010, a laser output from the laser emitter 120 may generate a scan point 2210. Referring to a scan plane 2200, the laser output from the laser emitter 120 and reflected from the scanner 220 may generate the scan point 2210 at a location near −90 degrees.

Specifically, in the first state, the laser output from the laser emitter 120 is incident on a part corresponding to the center of the scanner 220 when viewed from the front, so the laser may generate the scan point 2210 at the center location in the z direction on the scan plane 2200.

In addition, referring to the top view 2000 in the second state 2020, a laser output from the laser emitter 120 may be reflected from the scanner 220 and may be emitted forward.

In addition, referring to the front view 2100 in the second state 2020, a laser output from the laser emitter 120 may be output downward, may be reflected from the scanner 220, and may be emitted forward.

In addition, referring to the top view 2000 and the front view 2100 in the second state 2020, a laser output from the laser emitter 120 may be incident on a part spaced apart from the center of the scanner 220 when viewed from the top, and may be incident on a part corresponding to the center of the scanner 220 when viewed from the front.

In addition, in the second state 2020, a laser output from the laser emitter 120 may generate a scan point 2220. Referring to the scan plane 2200, the laser output from the laser emitter 120 and reflected from the scanner 220 may generate the scan point 2220 at a location near 0 degrees.

Specifically, in the second state 2020, the laser output from the laser emitter 120 is incident on a part spaced upward from the center of the scanner 220 when viewed from the front, so the laser may generate the scan point 2220 at a location in the +z direction on the scan plane 2200.

In addition, referring to the top view 2000 in the third state 2030, a laser output from the laser emitter 120 may be reflected from the scanner 220 and may be emitted in the right direction.

In addition, referring to the front view 2100 in the third state 2030, a laser output from the laser emitter 120 may be output downward, may be reflected from the scanner 220, and may be emitted in the right direction.

In addition, referring to the top view 2000 and the front view 2100 in the third state 2030, a laser output from the laser emitter 120 may be incident on a part spaced apart from the center of the scanner 220 when viewed from the top, and may be incident on a part corresponding to the center of the scanner 220 when viewed from the front.

In addition, in the third state 2030, a laser output from the laser emitter 120 may generate a scan point 2230. Referring to the scan plane 2200, the laser output from the laser emitter 120 and reflected from the scanner 220 may generate the scan point 2230 at a location near +90 degrees.

Specifically, in the third state 2030, the laser output from the laser emitter 120 is incident on a part corresponding to the center of the scanner 220 when viewed from the front, so the laser may generate the scan point 2230 at the center location in the z direction on the scan plane 2200.

### 3.2 Arrangement in and a Scan Point of a LiDAR Device According to Another Embodiment

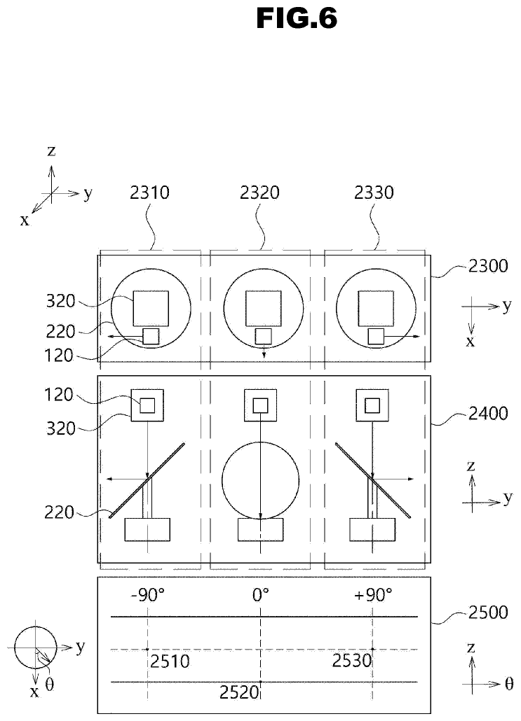

FIG. 6 is a diagram illustrating an arrangement relationship between elements included in a LiDAR device according to another embodiment, and an emission direction and a scan point of a laser.

Definitions of terms for describing FIG. 6 have been described with reference to FIG. 5, so a detailed description will be omitted.

Referring to FIG. 6, a LiDAR device according to an embodiment may include a laser emitter 120, a scanner 220, and a detector 320.

In addition, the scanner 220 may rotate around an axis of rotation.

Herein, the scanner 220 may rotate and may thus be in a first state 2310, a second state 2320, and a third state 2330.

In addition, referring to FIG. 6, it is shown that a top view 2300 and a front view 2400 in the first state 2310, the second state 2320, and the third state 2330.

Herein, referring to the top view 2300 and the front view 2400, an arrangement relationship between the laser emitter 120, the scanner 220, and the detector 320 included in the LiDAR device may be understood.

In addition, referring to the top view 2300, the laser emitter 120 may be placed in front of the axis of rotation of the scanner 220. Furthermore, the detector 320 may be placed to correspond to the axis of rotation of the scanner 220.

In addition, referring to the front view 2400, the laser emitter 120 may be placed above the scanner 220. In addition, the detector 320 may be placed above the scanner 220.

Accordingly, the laser emitter 120 may be placed above the scanner 220 and may be placed in front of the axis of rotation of the scanner 220. In addition, the detector 320 may be placed above the scanner 220 and may be placed to correspond to the axis of rotation of the scanner 220.

In addition, referring to the top view 2300 in the first state 2310, a laser output from the laser emitter 120 may be reflected from the scanner 220 and may be emitted in the left direction.

In addition, referring to the front view 2400 in the first state 2310, a laser output from the laser emitter 120 may be output downward, may be reflected from the scanner 220, and may be emitted in the left direction.

In addition, referring to the top view 2300 and the front view 2400 in the first state 2310, a laser output from the laser emitter 120 may be incident on a part spaced apart from the center of the scanner 220 when viewed from the top, and may be incident on a part corresponding to the center of the scanner 220 when viewed from the front.

In addition, in the first state 2310, a laser output from the laser emitter 120 may generate a scan point 2510. Referring to a scan plane 2500, the laser output from the laser emitter 120 and reflected from the scanner 220 may generate the scan point 2510 at a location near −90 degrees.

Specifically, in the first state, the laser output from the laser emitter 120 is incident on a part corresponding to the center of the scanner 220 when viewed from the front, so the laser may generate the scan point 2510 at the center location in the z direction on the scan plane 2500.

In addition, referring to the top view 2300 in the second state 2320, a laser output from the laser emitter 120 may be reflected from the scanner 220 and may be emitted forward.

In addition, referring to the front view 2400 in the second state 2320, a laser output from the laser emitter 120 may be output downward, may be reflected from the scanner 220, and may be emitted forward.

In addition, referring to the top view 2300 and the front view 2400 in the second state 2320, a laser output from the laser emitter 120 may be incident on a part spaced apart from the center of the scanner 220 when viewed from the top, and may be incident on a part corresponding to the center of the scanner 220 when viewed from the front.

In addition, in the second state 2320, a laser output from the laser emitter 120 may generate a scan point 2520. Referring to the scan plane 2500, the laser output from the laser emitter 120 and reflected from the scanner 220 may generate the scan point 2520 at a location near 0 degrees.

Specifically, in the second state 2320, the laser output from the laser emitter 120 is incident on a part spaced downward from the center of the scanner 220 when viewed from the front, so the laser may generate the scan point 2520 at a location in the −z direction on the scan plane 2500.

In addition, referring to the top view 2300 in the third state 2330, a laser output from the laser emitter 120 may be reflected from the scanner 220 and may be emitted in the right direction.

In addition, referring to the front view 2400 in the third state 2330, a laser output from the laser emitter 120 may be output downward, may be reflected from the scanner 220, and may be emitted in the right direction.

In addition, referring to the top view 2300 and the front view 2400 in the third state 2330, a laser output from the laser emitter 120 may be incident on a part spaced apart from the center of the scanner 220 when viewed from the top, and may be incident on a part corresponding to the center of the scanner 220 when viewed from the front.

In addition, in the third state 2330, a laser output from the laser emitter 120 may generate a scan point 2530. Referring to the scan plane 2500, the laser output from the laser emitter 120 and reflected from the scanner 220 may generate the scan point 2530 at a location near +90 degrees.

Specifically, in the third state 2330, the laser output from the laser emitter 120 is incident on a part corresponding to the center of the scanner 220 when viewed from the front, so the laser may generate the scan point 2530 at the center location in the z direction on the scan plane 2500.

### 3.3 Arrangement in and a Scan Point of a LiDAR Device According to Still Another Embodiment

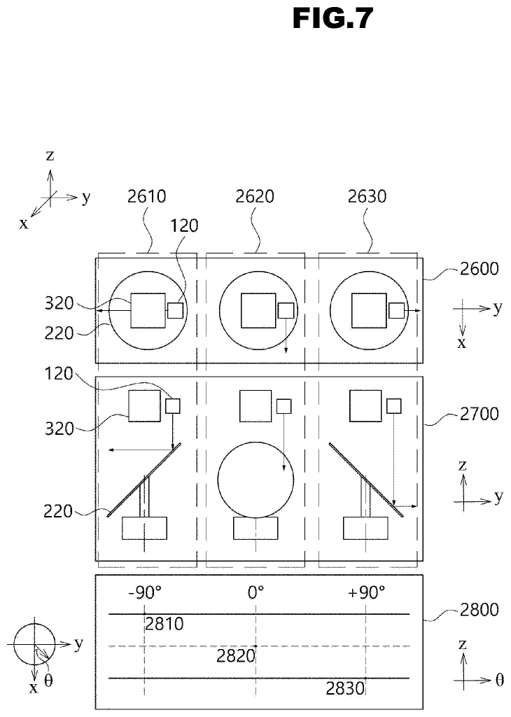

FIG. 7 is a diagram illustrating an arrangement relationship between elements included in a LiDAR device according to another embodiment, and an emission direction and a scan point of a laser.

Definitions of terms for describing FIG. 7 have been described with reference to FIG. 5, so a detailed description will be omitted.

Referring to FIG. 7, a LiDAR device according to an embodiment may include a laser emitter 120, a scanner 220, and a detector 320.

In addition, the scanner 220 may rotate around an axis of rotation.

Herein, the scanner 220 may rotate and may thus be in a first state 2610, a second state 2620, and a third state 2630.

In addition, referring to FIG. 7, it is shown that a top view 2600 and a front view 2700 in the first state 2610, the second state 2620, and the third state 2630.

Herein, referring to the top view 2600 and the front view 2700, an arrangement relationship between the laser emitter 120, the scanner 220, and the detector 320 included in the LiDAR device may be understood.

In addition, referring to the top view 2600, the laser emitter 120 may be placed to the right of the axis of rotation of the scanner 220. Furthermore, the detector 320 may be placed to correspond to the axis of rotation of the scanner 220.

In addition, referring to the front view 2600, the laser emitter 120 may be placed above the scanner 220. In addition, the detector 320 may be placed above the scanner 220.

Accordingly, the laser emitter 120 may be placed above the scanner 220 and may be placed to the right of the axis of rotation of the scanner 220. In addition, the detector 320 may be placed above the scanner 220 and may be placed to correspond to the axis of rotation of the scanner 220.

In addition, referring to the top view 2600 in the first state 2610, a laser output from the laser emitter 120 may be reflected from the scanner 220 and may be emitted in the left direction.

In addition, referring to the front view 2700 in the first state 2610, a laser output from the laser emitter 120 may be output downward, may be reflected from the scanner 220, and may be emitted in the left direction.

In addition, referring to the top view 2600 and the front view 2700 in the first state 2610, a laser output from the laser emitter 120 may be incident on a part spaced apart from the center of the scanner 220 when viewed from the top, and may be incident on a part spaced upward from the center of the scanner 220 when viewed from the front.

In addition, in the first state 2610, a laser output from the laser emitter 120 may generate a scan point 2810. Referring to a scan plane 2800, the laser output from the laser emitter 120 and reflected from the scanner 220 may generate the scan point 2810 at a location near −90 degrees.

Specifically, in the first state, the laser output from the laser emitter 120 is incident on a part spaced upward from the scanner 220 when viewed from the front, so the laser may generate the scan point 2810 at a location spaced in the +z direction on the scan plane 2800.

In addition, referring to the top view 2600 in the second state 2620, a laser output from the laser emitter 120 may be reflected from the scanner 220 and may be emitted forward.

In addition, referring to the front view 2600 in the second state 2620, a laser output from the laser emitter 120 may be output downward, may be reflected from the scanner 220, and may be emitted forward.

In addition, referring to the top view 2600 and the front view 2700 in the second state 2620, a laser output from the laser emitter 120 may be incident on a part spaced apart from the center of the scanner 220 when viewed from the top, and may be incident on a part spaced rightward from the center of the scanner 220 when viewed from the front.

In addition, in the second state 2620, a laser output from the laser emitter 120 may generate a scan point 2820. Referring to the scan plane 2800, the laser output from the laser emitter 120 and reflected from the scanner 220 may generate the scan point 2820 at a location near 0 degrees.

Specifically, in the second state, the laser output from the laser emitter 120 is incident on a part corresponding to the up-down center of the scanner 220 when viewed from the front, so the laser may generate the scan point 2820 at a location corresponding to the center in the z direction on the scan plane 2800.

In addition, referring to the top view 2600 in the third state 2630, a laser output from the laser emitter 120 may be reflected from the scanner 220 and may be emitted in the right direction.

In addition, referring to the front view 2600 in the third state 2630, a laser output from the laser emitter 120 may be output downward, may be reflected from the scanner 220, and may be emitted in the right direction.

In addition, referring to the top view 2600 and the front view 2700 in the third state 2630, a laser output from the laser emitter 120 may be incident on a part spaced apart from the center of the scanner 220 when viewed from the top, and may be incident on a part spaced downward from the center of the scanner 220 when viewed from the front.

In addition, in the third state 2630, a laser output from the laser emitter 120 may generate a scan point 2830. Referring to the scan plane 2800, the laser output from the laser emitter 120 and reflected from the scanner 220 may generate the scan point 2830 at a location near +90 degrees.

Specifically, in the third state, the laser output from the laser emitter 120 is incident on a part spaced downward from the scanner 220 when viewed from the front, so the laser may generate the scan point 2830 at a location spaced in the −z direction on the scan plane 2800.

As described above with reference to FIGS. 5 to 7, when the laser emitter 120 is placed spaced apart from the axis of rotation of the scanner 220, the generation location of the scan point varies in the z direction according to the placement of the laser emitter 120 and the rotation of the scanner 220. Therefore, it is necessary to consider effective placement of the laser emitter 120 considering the purpose of use and the effects of the LiDAR device.

For example, in order to minimize the distance between the scan points in the z direction on the scan plane, it is preferable that the laser emitter is placed ahead of or behind the axis of rotation of the scanner when viewed from the top.

In addition, for example, in order to make up for the slope of the ground, it is preferable that the laser emitter is placed to the left or right of the axis of rotation of the scanner when viewed from the top.

### 4. Various Embodiments of a LiDAR Device

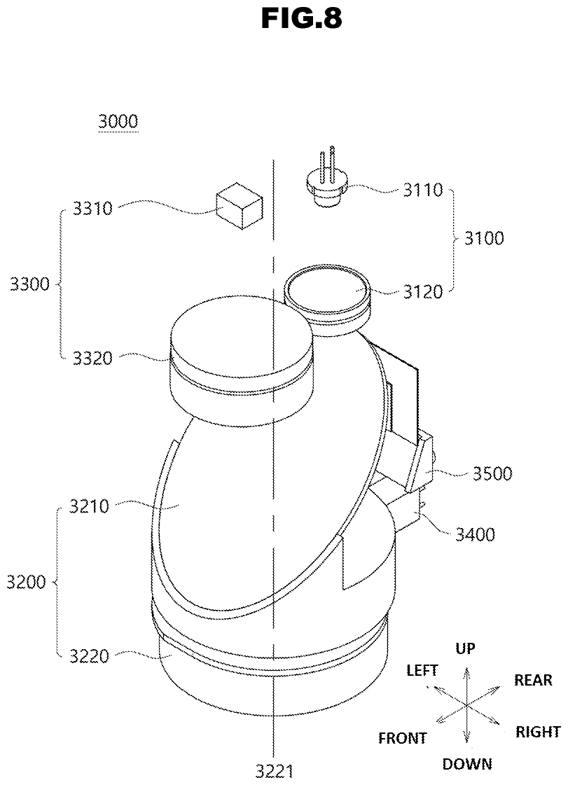

FIG. 8 is a perspective view of a LiDAR device according to an embodiment.

Referring to FIG. 8, a LiDAR device 3000 according to an embodiment may include a laser emitter 3100, a scanner 3200, a detector 3300, an angle measurement part 3400, and a fixed mirror 3500.

Furthermore, the laser emitter 3100 may include a laser output device 3110 and an emission lens 3120, but is not limited thereto.

Furthermore, the scanner 3200 may include a reflective surface 3210 and a rotary motor 3220, but is not limited thereto.

Furthermore, the detector 3300 may include a detection sensor 3310 and a light-receiving lens 3320, but is not limited thereto.

In addition, the above-described details may be applied to the laser emitter 3100, the scanner 3200, and the detector 3300, so a redundant description will be omitted.

Furthermore, the angle measurement part 3400 may measure a rotation angle of the scanner 3200.

Furthermore, the angle measurement part 3400 may be provided in the form of a photo coupler, a photo reflector, an encoder, etc., but is not limited thereto.

Furthermore, the fixed mirror 3500 may be a member for measuring at least one reference for distance measurement.

For example, at least one reference information for distance measurement may be acquired using time and intensity information of a laser output from the laser emitter 3100 and reflected from the fixed mirror 3500 and then acquired by the detector 3300, but no limitation thereto is imposed.

For a more specific example, a first light path of a laser output from the laser emitter 3100 and acquired (or received) by the fixed mirror 3500 and a second light path of the laser reflected by the fixed mirror 3500 and acquired by the detector may be set as a reference light path. Herein, a reference measurement distance may be acquired from a time interval between a time point of generation of a trigger signal for outputting the laser from the laser emitter 3100 and a time point of detection of the laser by the detector 3300. A reference correction value may be acquired on the basis of a difference between the length of the reference light path and the reference measurement distance. However, no limitation thereto is imposed.

In addition, for a more specific example, a table for a value of [reflectance/laser power] may be acquired on the basis of intensity information of a laser output from the laser emitter 3100 and reflected from the fixed mirror 3500 and then acquired by the detector 3300, but is not limited thereto.

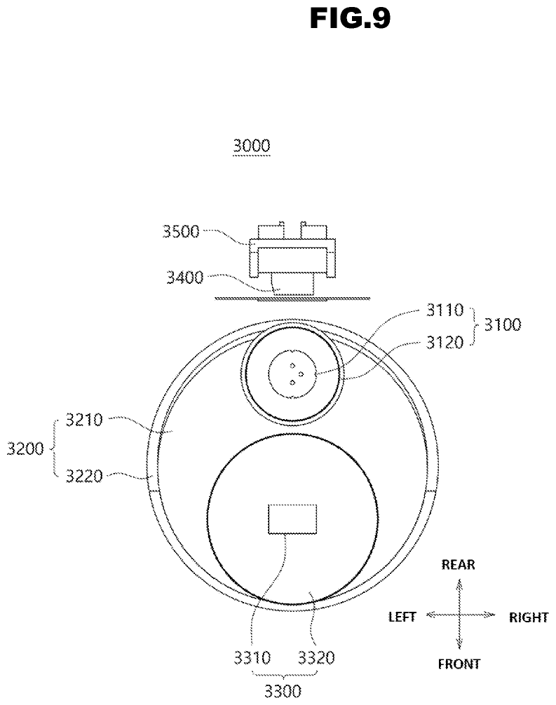

FIG. 9 is a top view of a LiDAR device according to an embodiment.

Referring to FIG. 9, a LiDAR device 3000 according to an embodiment may include a laser emitter 3100, a scanner 3200, a detector 3300, an angle measurement part 3400, and a fixed mirror 3500.

Herein, the above-described details may be applied to each element of the LiDAR device 3000, so a redundant description will be omitted.

Referring to FIG. 9, when viewed from the top of the LiDAR device 3000, the scanner 3200 may be provided in the shape of a circular plate.

In addition, when viewed from the top of the LiDAR device 3000, the laser emitter 3100 and the detector 3300 may be placed to be located in a region of the scanner 3200.

In addition, when viewed from the top of the LiDAR device 3000, the laser emitter 3100 may be placed to be closer to the fixed mirror 3500 than the detector 3300.

In addition, when viewed from the top of the LiDAR device 3000, the fixed mirror 3500 may be located behind the scanner 3200.

In addition, when viewed from the top of the LiDAR device 3000, the fixed mirror 3500 may be placed to have a thickness. This may mean that the fixed mirror 3500 is placed at a predetermined angle with respect to an axis of rotation of a rotary motor 3220, but is not limited thereto.

In addition, when viewed from the top of the LiDAR device 3000, the angle measurement part 3400 may be placed to be at least partially overlapped by the fixed mirror 3500.

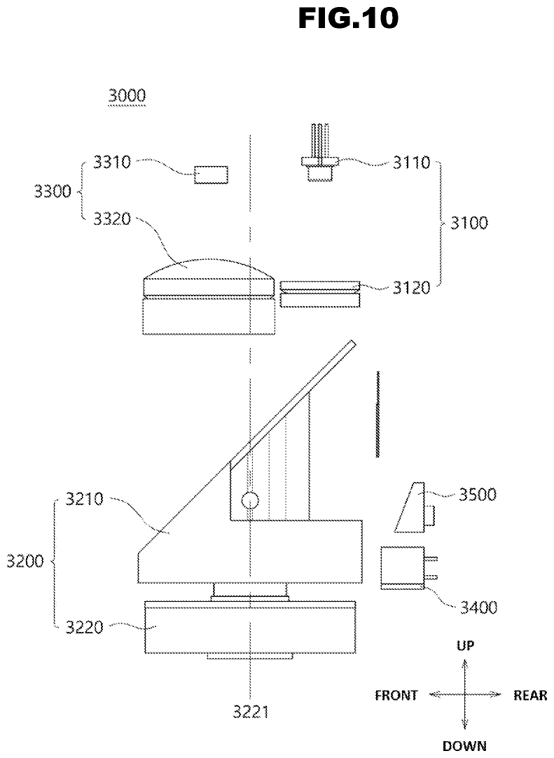

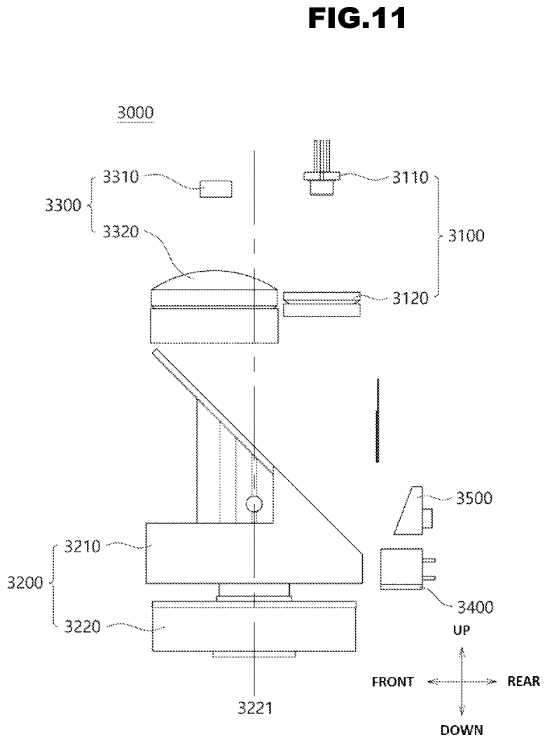

FIGS. 10 and 11 are side views of a LiDAR device according to an embodiment.

Referring to FIGS. 10 and 11, a LiDAR device 3000 according to an embodiment may include a laser emitter 3100, a scanner 3200, a detector 3300, an angle measurement part 3400, and a fixed mirror 3500.

Herein, the above-described details may be applied to each element of the LiDAR device 3000, so a redundant description will be omitted.

Referring to FIG. 10, the scanner 3200 may have a first position. Herein, the first position may mean a position of the scanner 3200 at a time point during the rotation operation of the scanner 3200. Referring to FIG. 11, the scanner 3200 may have a second position. Herein, the second position may mean a position of the scanner 3200 at a time point during the rotation operation of the scanner 3200. The second position may mean a position resulting from rotation by 180 degrees from the first position, but is not limited thereto.

Referring to FIG. 10, when the scanner 3200 is in the first position, the shortest vertical distance from the laser emitter 3100 to a reflective surface 3210 may be shorter than the shortest vertical distance from the detector 3300 to the reflective surface 3210.

In addition, when viewed from one side of the LiDAR device 3000 and when the scanner 3200 is in the first position, a laser output from the laser emitter 3100 may be reflected from an upper region of the reflective surface 3210 and may be emitted forward, and the laser acquired from the front by the reflective surface 3210 may be reflected from a lower region of the reflective surface 3210 and may be acquired by the detector 3300.

In addition, referring to FIG. 11, when the scanner 3200 is in the second position, the shortest vertical distance from the laser emitter 3100 to the reflective surface 3210 may be longer than the shortest vertical distance from the detector 3300 to the reflective surface 3210.

In addition, when viewed from one side of the LiDAR device 3000 and when the scanner 3200 is in the second position, a laser output from the laser emitter 3100 may be reflected from the lower region of the reflective surface 3210 and may be emitted to the fixed mirror 3500, and the laser reflected from the fixed mirror 3500 and acquired by the reflective surface 3210 may be reflected from the upper region of the reflective surface 3210 and may be acquired by the detector 3300.

In addition, when viewed from one side of the LiDAR device 3000, the laser emitter 3100 may be placed on one side from an axis of rotation of a rotary motor 3220 included in the scanner 3200, and the detector 3300 may be placed on another side from the axis of rotation of the rotary motor 3221 included in the scanner 3200.

In addition, when viewed from one side of the LiDAR device 3000, the fixed mirror 3500 may be placed to be closer to the laser emitter 3100 than to the detector 3300.

In addition, when viewed from one side of the LiDAR device 3000, the fixed mirror 3500 may be placed below the laser emitter 3100 and the detector 3300.

In addition, when viewed from one side of the LiDAR device 3000, the fixed mirror 3500 may be located in the vertical direction at a region corresponding to a part of the reflective surface 3210 included in the scanner 3200. This may mean that a vertical location value of the fixed mirror 3500 and a vertical location value of the reflective surface 3210 overlap at least partially, but is not limited thereto.

In addition, when viewed from one side of the LiDAR device 3000, the reflective surface 3210 included in the scanner 3200 may be placed at a first predetermined angle with respect to the axis of rotation of the rotary motor 3221, and the fixed mirror 3500 may be placed at a second predetermined angle with respect to the axis of rotation of the rotary motor 3221.

Herein, the first predetermined angle and the second predetermined angle may be different from each other.

Furthermore, herein, the second predetermined angle may be smaller than the first predetermined angle.

In addition, when viewed from one side of the LiDAR device 3000, the angle measurement part 3400 may be placed below the fixed mirror 3500.

In addition, when viewed from one side of the LiDAR device 3000, the angle measurement part 3400 may be located in the vertical direction at a region not corresponding to a part of the reflective surface 3210 included in the scanner 3200. This may mean that the vertical location value of the angle measurement part 3400 and the vertical location value of the reflective surface 3210 do not overlap at least partially, but is not limited thereto.

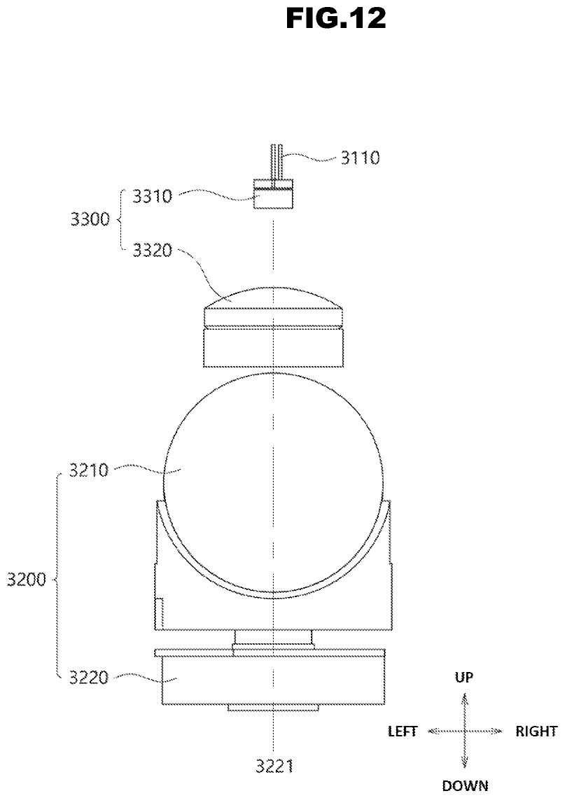

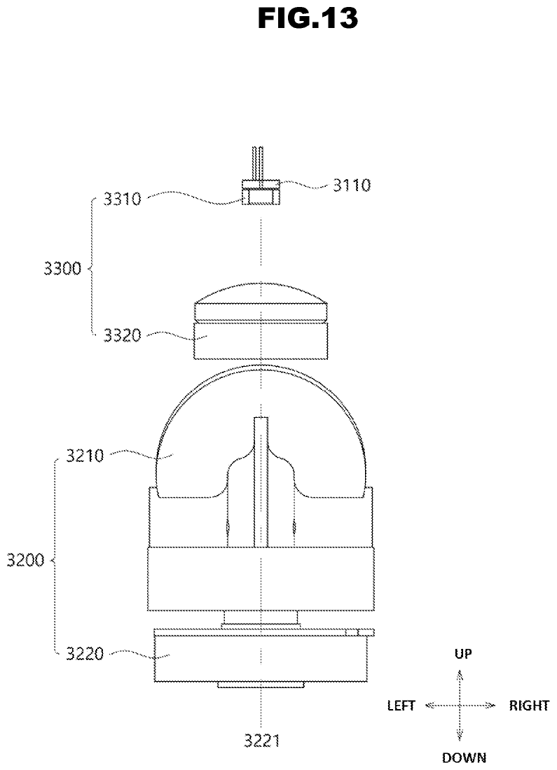

FIGS. 12 and 13 are front views of a LiDAR device according to an embodiment.

Referring to FIGS. 12 and 13, a LiDAR device 3000 according to an embodiment may include a laser emitter 3100, a scanner 3200, a detector 3300, an angle measurement part 3400, and a fixed mirror 3500.

Herein, the above-described details may be applied to each element of the LiDAR device 3000, so a redundant description will be omitted.

Referring to FIG. 12, the scanner 3200 may have a first position. Herein, the first position may mean a position of the scanner 3200 at a time point during the rotation operation of the scanner 3200. Referring to FIG. 13, the scanner 3200 may have a second position. Herein, the second position may mean a position of the scanner 3200 at a time point during the rotation operation of the scanner 3200. The second position may mean a position resulting from rotation by 180 degrees from the first position, but is not limited thereto.

Referring to FIG. 12, when viewed from the front of the LiDAR device 3000 and when the scanner 3200 is in the first position, a reflective surface 3210 included in the scanner 3200 may look like an ellipse shape.

In addition, referring to FIG. 13, when viewed from the front of the LiDAR device 3000 and when the scanner 3200 is in the second position, the reflective surface 3210 included in the scanner 3200 may be invisible.

In addition, when viewed from the front of the LiDAR device 3000, the laser emitter 3100 and the detector 3300 may be placed to overlap at least partially.

In addition, when viewed from the front of the LiDAR device 3000, the laser emitter 3100 and the detector 3300 may be placed to overlap with an axis 3221 of rotation of a rotary motor 3220 included in the scanner 3200.

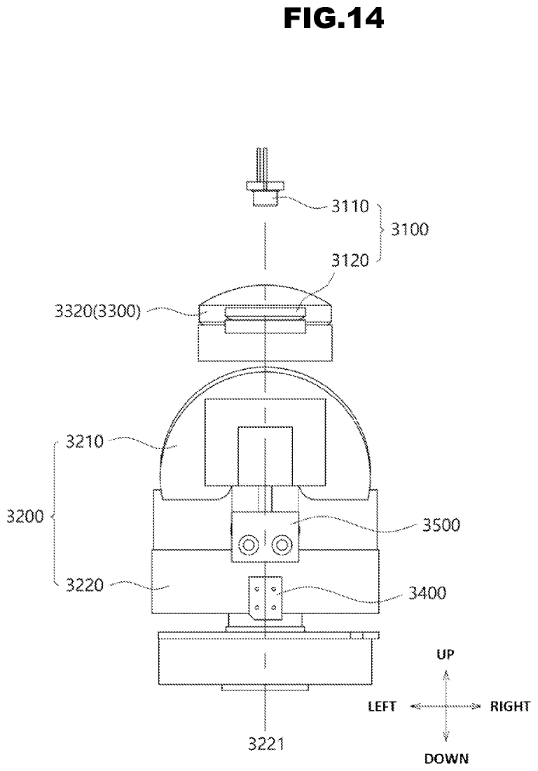

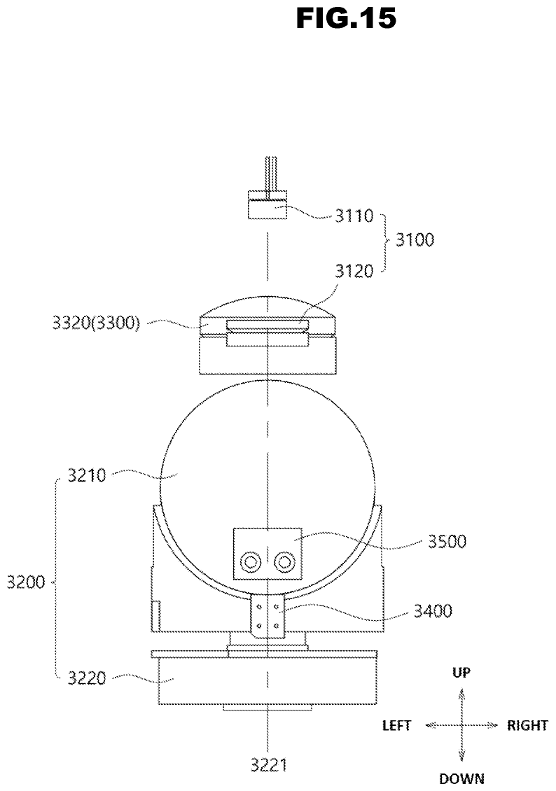

FIGS. 14 and 15 are rear views of a LiDAR device according to an embodiment.

Referring to FIGS. 14 and 15, a LiDAR device 3000 according to an embodiment may include a laser emitter 3100, a scanner 3200, a detector 3300, an angle measurement part 3400, and a fixed mirror 3500.

Herein, the above-described details may be applied to each element of the LiDAR device 3000, so a redundant description will be omitted.

Referring to FIG. 14, the scanner 3200 may have a first position. Herein, the first position may mean a position of the scanner 3200 at a time point during the rotation operation of the scanner 3200. Referring to FIG. 15, the scanner 3200 may have a second position. Herein, the second position may mean a position of the scanner 3200 at a time point during the rotation operation of the scanner 3200. The second position may mean a position resulting from rotation by 180 degrees from the first position, but is not limited thereto.

Referring to FIG. 14, when viewed from the rear of the LiDAR device 3000 and when the scanner 3200 is in the first position, a reflective surface 3210 included in the scanner 3200 may be invisible.

In addition, referring to FIG. 15, when viewed from the rear of the LiDAR device 3000 and when the scanner 3200 is in the second position, the reflective surface 3210 included in the scanner 3200 may look like an ellipse shape.

In addition, when viewed from the rear of the LiDAR device 3000, the laser emitter 3100, the detector 3300, the angle measurement part 3400, and the fixed mirror 3500 may be placed to overlap with an axis 3221 of rotation of a rotary motor 3220 included in the scanner 3200.

In addition, when viewed from the rear of the LiDAR device 3000, the fixed mirror 3500 may be placed below the laser emitter 3100 and the detector 3300.

In addition, when viewed from the rear of the LiDAR device 3000, the fixed mirror 3500 may be located at a region corresponding to a part of the reflective surface 3210 included in the scanner 3200. This may mean that a vertical location value of the fixed mirror 3500 and a vertical location value of the reflective surface 3210 overlap at least partially, but is not limited thereto.

In addition, when viewed from the rear of the LiDAR device 3000, the fixed mirror 3500 may be located to correspond to a lower region of the reflective surface 3210 included in the scanner 3200.

In addition, when viewed from the rear of the LiDAR device 3000, the angle measurement part 3400 may be placed below the fixed mirror 3500.

In addition, when viewed from the rear of the LiDAR device 3000, the angle measurement part 3400 may be located not to correspond to the reflective surface 3210 included in the scanner 3200.

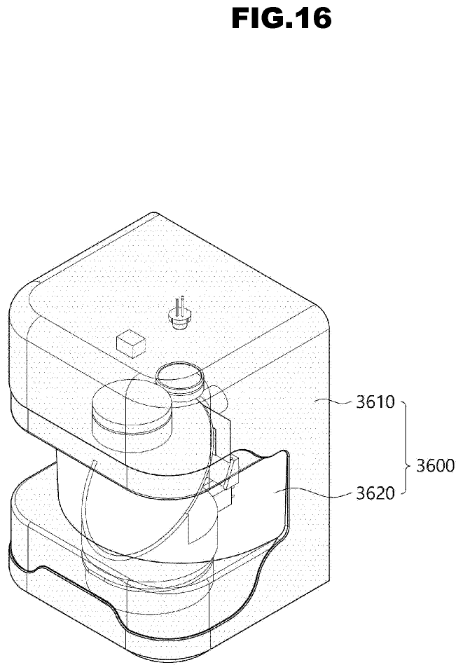

FIG. 16 is a perspective view of a LiDAR device according to an embodiment.

Referring to FIG. 16, a LiDAR device 3000 according to an embodiment may include a laser emitter 3100, a scanner 3200, a detector 3300, an angle measurement part 3400, a fixed mirror 3500, and a housing 3600.

Herein, the above-described details may be applied to the laser emitter 3100, the scanner 3200, the detector 3300, the angle measurement part 3400, and the fixed mirror 3500, so a redundant description will be omitted.

Referring to FIG. 16, the laser emitter 3100, the scanner 3200, the detector 3300, the angle measurement part 3400, and the fixed mirror 3500 may be included within the housing.

Furthermore, the housing 3600 may comprise an outer cover 3610 and a window 3620.

In addition, the inside of the housing 3600 may be sealed by the outer cover 3610 and the window 3620.

Herein, the outer cover 3610 may protect the elements of the LiDAR device 3000 located in the housing from an external environment.

Furthermore, the outer cover 3610 may optically shield to prevent the elements of the LiDAR device 3000 located in the housing from being disturbed by external light.

In addition, the window 3620 may protect the elements of the LiDAR device 3000 located in the housing from the external environment.

Furthermore, the window 3620 may have an optical window so that a laser output from the laser emitter 3100 can be emitted to the outside and the laser reflected from an object is acquired by the detector 3300 through the optical window. For example, a laser output from the laser emitter 3100 and reflected from the scanner 3200 can pass through the window 3620, and the laser reflected from an object can pass through the window 3620 so that the laser reflected from the object is reflected from the scanner 3200 and is acquired by the detector 3300.

Furthermore, the window 3620 may be placed to constitute a partial region of the housing 3600.

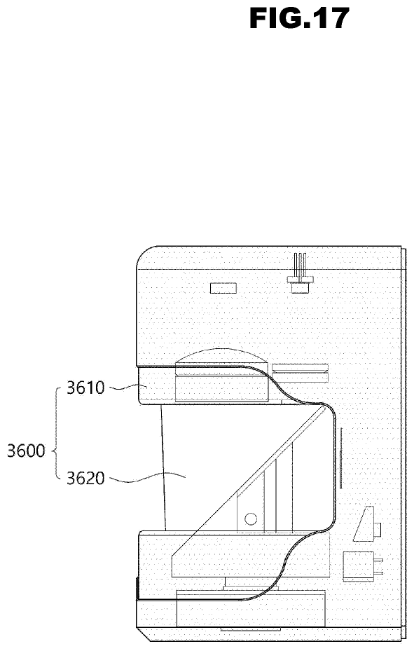

FIG. 17 is a side view of a LiDAR device according to an embodiment.

Referring to FIG. 17, a LiDAR device 3000 according to an embodiment may include a laser emitter 3100, a scanner 3200, a detector 3300, an angle measurement part 3400, a fixed mirror 3500, and a housing 3600.

Herein, the above-described details may be applied to each element of the LiDAR device 3000, so a redundant description will be omitted.

Referring to FIG. 17, when viewed from one side of the LiDAR device 3000, a window 3620 included in the housing 3600 may be located at a region of the housing 3600.

In addition, when viewed from one side of the LiDAR device 3000, the window 3620 included in the housing 3600 may be located such that the window 3620 and at least a part of a reflective surface 3210 included in the scanner 3200 overlap. This may mean that when viewed from one side of the LiDAR device 3000, at least a part of the reflective surface 3210 is optically visible through the window 3620, wherein being optically visible may mean that observation is achieved using a sensor for acquiring light of at least one wavelength band. However, no limitation thereto is imposed, and a concept that the window 3620 and at least a part of the reflective surface 3210 are located at physically overlapping regions may be included.

In addition, when viewed from one side of the LiDAR device 3000, the window 3620 included in the housing 4600 may be located such that the window 3620 and the laser emitter 3100 do not overlap. This may mean that when viewed from one side of the LiDAR device 3000, the laser emitter 3100 is optically invisible through the window 3620, wherein being optically invisible may mean that observation is not achieved using a sensor for acquiring light of at least one wavelength band. However, no limitation thereto is imposed, and a concept that the window 3620 and the laser emitter 3100 are located at regions that do not physically overlap may be included.

In addition, when viewed from one side of the LiDAR device 3000, the window 3620 included in the housing 3600 may be located such that the window 3620 and the detector 3300 do not overlap.

In addition, when viewed from one side of the LiDAR device 3000, the window 3620 included in the housing 3600 may be located such that the window 3620 and a rotary motor 3220 included in the scanner 3200 do not overlap.

In addition, when viewed from one side of the LiDAR device 3000, the window 3620 included in the housing 3600 may be located such that the window 3620 and the angle measurement part 3400 do not overlap.

In addition, when viewed from one side of the LiDAR device 3000, the window 3620 included in the housing 3600 may be located such that the window 3620 and the fixed mirror 3500 do not overlap.

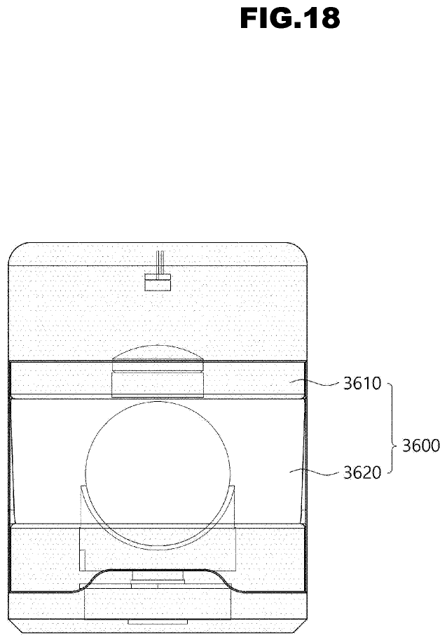

FIG. 18 is a front view of a LiDAR device according to an embodiment.

Referring to FIG. 18, a LiDAR device 3000 according to an embodiment may include a laser emitter 3100, a scanner 3200, a detector 3300, an angle measurement part 3400, a fixed mirror 3500, and a housing 3600.

Herein, the above-described details may be applied to each element of the LiDAR device 3000, so a redundant description will be omitted.

Referring to FIG. 18, when viewed from the front of the LiDAR device 3000, a window 3620 included in the housing 3600 may be located at a region of the housing 3600.

In addition, when viewed from the front of the LiDAR device 3000, the window 3620 included in the housing 3600 may be located such that the window 3620 and at least a part of a reflective surface 3210 included in the scanner 3200 overlap. This may mean that when viewed from the front of the LiDAR device 3000, at least a part of the reflective surface 3210 is optically visible through the window 3620, wherein being optically visible may mean that observation is achieved using a sensor for acquiring light of at least one wavelength band. However, no limitation thereto is imposed, and a concept that the window 3620 and at least a part of the reflective surface 3210 are located at physically overlapping regions may be included.

For example, in FIG. 18, an upper region and a middle region of the reflective surface 3210 and the window 3620 may overlap, but are not limited thereto.

In addition, when viewed from the front of the LiDAR device 3000, the area of the region of the window 3620 included in the housing 3600 may be larger than the area of the reflective surface 3210 included in the scanner 3200.

In addition, when viewed from the front of the LiDAR device 3000, the window 3620 included in the housing 3600 may be located such that the window 3620 and at least a part of the reflective surface 3210 included in the scanner 3200 do not overlap. This may mean that when viewed from the front of the LiDAR device 3000, at least a part of the reflective surface 3210 is optically invisible through the window 3620. For example, in FIG. 18, a lower region of the reflective surface 3210 and the window 3620 may not over.

In addition, when viewed from the front of the LiDAR device 3000, the window 3620 included in the housing 4600 may be located such that the window 3620 and the laser emitter 3100 do not overlap. This may mean that when viewed from one side of the LiDAR device 3000, the laser emitter 3100 is optically invisible through the window 3620, wherein being optically invisible may mean that observation is not achieved using a sensor for acquiring light of at least one wavelength band. However, no limitation thereto is imposed, and a concept that the window 3620 and the laser emitter 3100 are located at regions that do not physically overlap may be included.

In addition, when viewed from the front of the LiDAR device 3000, the window 3620 included in the housing 3600 may be located such that the window 3620 and the detector 3300 do not overlap.

In addition, when viewed from the front of the LiDAR device 3000, the window 3620 included in the housing 3600 may be located such that the window 3620 and a rotary motor 3220 included in the scanner 3200 do not overlap.

In addition, when viewed from the front of the LiDAR device 3000, the window 3620 included in the housing 3600 may be located such that the window 3620 and the angle measurement part 3400 do not overlap.

In addition, when viewed from the front of the LiDAR device 3000, the window 3620 included in the housing 3600 may be located such that the window 3620 and the fixed mirror 3500 do not overlap.

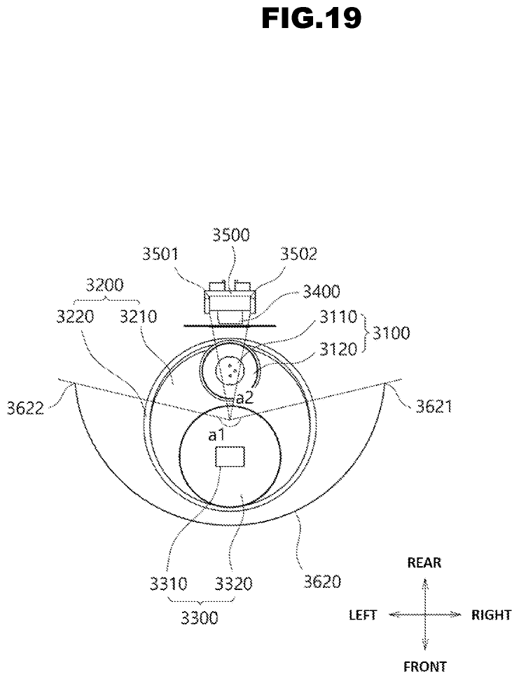

FIG. 19 is a top view of a LiDAR device according to an embodiment.

Referring to FIG. 19, a LiDAR device 3000 according to an embodiment may include a laser emitter 3100, a scanner 3200, a detector 3300, an angle measurement part 3400, a fixed mirror 3500, and a window 3620.

Herein, the above-described details may be applied to each element of the LiDAR device 3000, so a redundant description will be omitted.

Referring to FIG. 19, when viewed from the top of the LiDAR device 3000, the window 3620 may have a first window end 3621 and a second window end 3622.

Furthermore, when viewed from the top of the LiDAR device 3000, the window 3620 may be formed extending from the first window end 3621 to the second window end 3622.

Furthermore, when viewed from the top of the LiDAR device 3000, the window 3620 may be formed in the shape of an arc extending from the first window end 3621 to the second window end 3622.

In addition, when viewed from the top of the LiDAR device 3000, the fixed mirror 3500 may have a first mirror end 3501 and a second mirror end 3502.

Furthermore, when viewed from the top of the LiDAR device 3000, the fixed mirror 3500 may be formed extending from the first mirror end 3501 to the second mirror end 3502.

Furthermore, when viewed from the top of the LiDAR device 3000, the fixed mirror 3500 may be formed in the shape of a quadrangle extending from the first mirror end 3501 to the second mirror end 3502.

In addition, when viewed from the top of the LiDAR device 3000, a first virtual line and a second virtual line may form a first angle a1 therebetween, wherein the first virtual line may be a line connecting the center of a reflective surface 3210 included in the scanner 3200 to the first window end 3621, and the second virtual line may be a line connecting the center of the reflective surface 3210 to the second window end 3622.

In addition, when viewed from the top of the LiDAR device 3000, a third virtual line and a fourth virtual line may form a second angle a2 therebetween, wherein the third virtual line may be a line connecting the center of the reflective surface 3210 to the first mirror end 3501, and the fourth virtual line may be a line connecting the center of the reflective surface 3210 to the second mirror end 3502.

Herein, the first angle a1 and the second angle a2 may be different from each other.

Furthermore, the first angle a1 may be wider than the second angle a2.

Furthermore, the first angle a1 may be equal to or wider than a 180 degree angle.

Furthermore, the second angle a2 may be equal to or narrower than a 20 degree angle.

In addition, when viewed from the top of the LiDAR device 3000, a first region and the detector 3300 may overlap at least partially, wherein the first region is a region surrounded by the first virtual line, the second virtual line, and the window 3620.

This may mean that when viewed from the top of the LiDAR device 3000, the detector 3300 is located such that the detector 3300 and the first region overlap at least partially.

In addition, when viewed from the top of the LiDAR device 3000, a second region and the laser emitter 3100 may overlap at least partially, wherein the second region is a region surrounded by the third virtual line, the fourth virtual line, and the fixed mirror 3500.

This may mean that when viewed from the top of the LiDAR device 3000, the laser emitter 3100 is located such that the laser emitter 3100 and the second region overlap at least partially.

In addition, when viewed from the top of the LiDAR device 3000, the area of the first region may be larger than the area of the second region.

In addition, when viewed from the top of the LiDAR device 3000, the reflective surface 3210 and the first region may overlap at least partially and the reflective surface 3210 and the second region may overlap at least partially.

Herein, when viewed from the top of the LiDAR device 3000, the area of the part of the reflective surface 3210 overlapped by the first region may be larger than the area of the part of the reflective surface 3210 overlapped by the second region.

In addition, when viewed from the top of the LiDAR device 3000, the first region and the second region may not overlap each other.

In addition, when viewed from the top of the LiDAR device 3000, the window 3620 may be located such that the window 3620 and the second region do not overlap.

In addition, when viewed from the top of the LiDAR device 3000, the fixed mirror 3500 may be located such that the fixed mirror 3500 and the first region do not overlap.

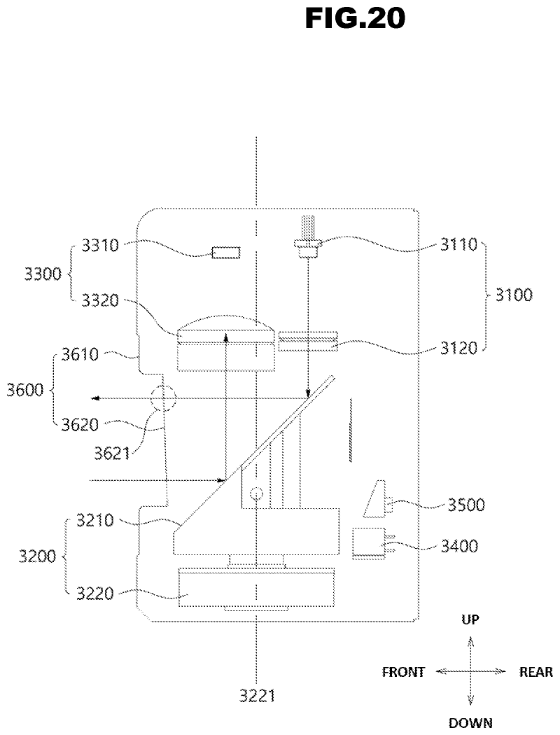

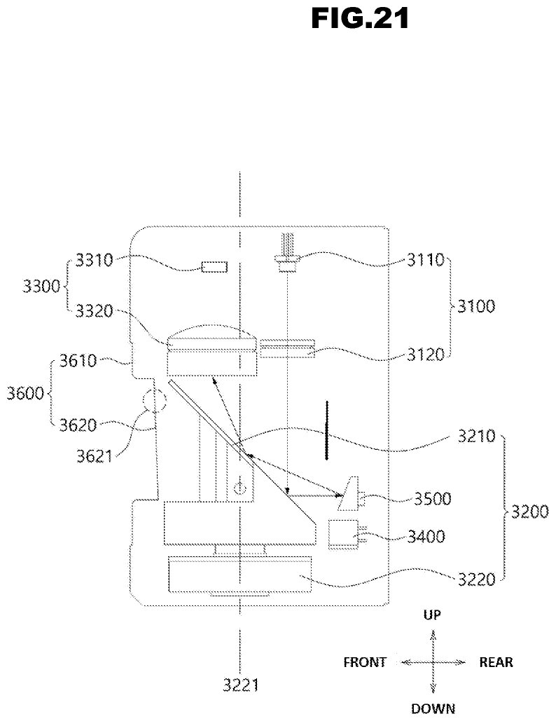

FIGS. 20 and 21 are side views of a LiDAR device according to an embodiment.

Referring to FIGS. 20 and 21, a LiDAR device 3000 according to an embodiment may include a laser emitter 3100, a scanner 3200, a detector 3300, an angle measurement part 3400, a fixed mirror 3500, and a housing 3600.

Herein, the above-described details may be applied to each element of the LiDAR device 3000, so a redundant description will be omitted.

Referring to FIG. 20, the scanner 3200 may have a first position. Herein, the first position may mean a position of the scanner 3200 at a time point during the rotation operation of the scanner 3200. Referring to FIG. 21, the scanner 3200 may have a second position. Herein, the second position may mean a position of the scanner 3200 at a time point during the rotation operation of the scanner 3200. The second position may mean a position resulting from rotation by 180 degrees from the first position, but is not limited thereto.

Herein, the first position may be a position included in a scan position, and the second position may be a position included in a reference measurement position.

Furthermore, the scan position may mean a position of the scanner in which a laser output from the laser emitter is emitted to the outside of the LiDAR device. The reference measurement position may mean a position of the scanner in which a laser output from the laser emitter is received by the detector along a preset reference light path. However, no limitation thereto is imposed.

Referring to FIG. 20, when viewed from one side of the LiDAR device 3000 and when the scanner 3200 is in the first position, a laser output from the laser emitter 3100 is reflected from a reflective surface 3210, and a first part 3621 of the window 3620 included in the housing 3600 may be located on the path of the laser reflected from the reflective surface 3210.

In addition, referring to FIG. 21, when viewed from one side of the LiDAR device 3000 and when the scanner 3200 is in the second position, a laser output from the laser emitter 3100 is reflected from the reflective surface 3210, and the fixed mirror 3500 may be located on the path of the laser reflected from the reflective surface 3210.

Herein, when viewed from one side of the LiDAR device 3000, the first part 3621 of the window 3620 and the fixed mirror 3500 may differ in vertical location. That is, a height of the first part 3621 may be different from a height of the fixed mirror 3500.

For example, the vertical location of the first part 3621 of the window 3620 may correspond to an upper region of the reflective surface 3210, and the vertical location of the fixed mirror 3500 may correspond to a lower region of the reflective surface 3210, but no limitation thereto is imposed.

In addition, when viewed from one side of the LiDAR device 3000, the reflective surface 3210 may be placed at a first predetermined angle with respect to an axis 3221 of rotation of a rotary motor 3220 included in the scanner 3200, and the fixed mirror 3500 may be placed at a second predetermined angle with respect to the axis 3221 of rotation, and the window 3620 may be placed at a third predetermined angle with respect to the axis 3221 of rotation.

Herein, the first to the third predetermined angles may be different from each other.

Furthermore, the first predetermined angle may be larger than the second predetermined angle, and the second predetermined angle may be larger than the third predetermined angle.

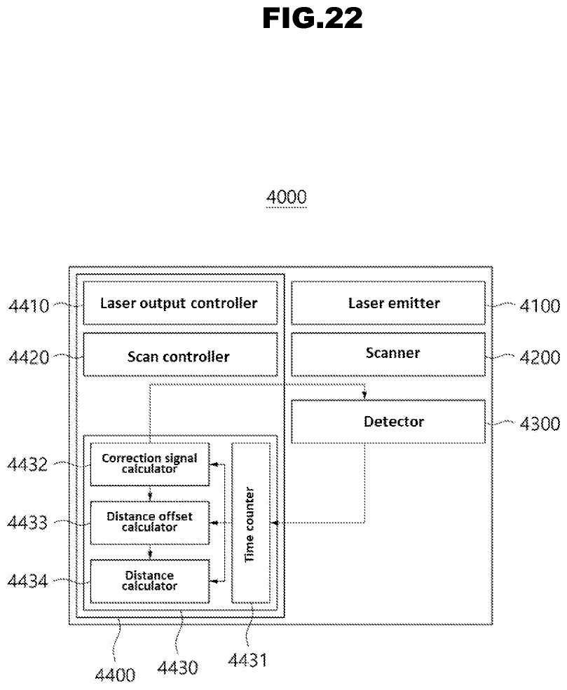

FIG. 22 is a diagram illustrating a LiDAR device according to an embodiment.

Referring to FIG. 22, a LiDAR device (4000) according to an embodiment may least one of the following elements: a laser emitter 4100, a scanner 4200, a detector 4300, and a controller 4400.

Herein, the above-described details may be applied to the laser emitter 4100, the scanner 4200, the detector 4300, and the controller 4400, so a redundant description will be omitted.

Furthermore, the controller 4400 may include at least one of the following elements: a laser output controller 4410, a scan controller 4420, and a detector controller 4430.

Herein, the laser output controller 4410 may control various operations of the laser emitter 4100.

For example, the laser output controller 4410 may generate a trigger signal for laser output, but is not limited thereto.

In addition, for example, the laser output controller 4410 may control the amount of voltage for laser output, but is not limited thereto.

In addition, for example, the laser output controller 4410 may control the amount of current for laser output, but is not limited thereto.

In addition, for example, the laser output controller 4410 may control the pulse width of a laser output, but is not limited thereto.

In addition, for example, the laser output controller 4410 may control the power of a laser output, but is not limited thereto.

In addition to the above-described details, the laser output controller 4410 may control various operations of the laser emitter 4100.

Herein, the controlling of the various operations of the laser emitter 4100 by the laser output controller 4410 may mean generating at least one signal for controlling the various operations of the laser emitter 4100, but is not limited thereto.

In addition, the scan controller 4420 may control various operations of the scanner 4200.

For example, the scan controller 4420 may control the rotation speed of the scanner 4200, but is not limited thereto.

In addition, for example, the scan controller 4420 may monitor the rotation angle of the scanner 4200, but is not limited thereto.

In addition, for example, the scan controller 4420 may control the rotation direction of the scanner 4200, but is not limited thereto.

In addition to the above-described details, the scan controller 4420 may control various operations of the scanner 4200.

Herein, the controlling of the various operations of the scanner 4200 by the scan controller 4420 may mean generating at least one signal for controlling the various operations of the scanner 4200, but is not limited thereto.

In addition, the detector controller 4430 may control various operations of the detector 4300, and may process a signal acquired from the detector 4300.

For example, the detector controller 4430 may control an operating voltage of the detector 4300, but is not limited thereto.

In addition, for example, the detector controller 4430 may control the on/off operation of the detector 4300, but is not limited thereto.

In addition, for example, the detector controller 4430 may determine a time point of acquisition of a signal acquired from the detector 4300, but is not limited thereto.

In addition, for example, the detector controller 4430 may calculate a correction signal on the basis of a signal acquired from the detector 4300 so as to control a voltage applied to the detector 4300, but is not limited thereto.

In addition, for example, the detector controller 4430 may calculate a distance offset on the basis of a signal acquired from the detector 4300, but is not limited thereto.

In addition, for example, the detector controller 4430 may calculate a distance to an object on the basis of a signal acquired from the detector 4300, but is not limited thereto.

In addition to the above-described details, the detector controller 4430 may control various operations of the detector 4300, or may process a signal acquired from the detector 4300.

Herein, the controlling of the various operations of the detector 4300 by the detector controller 4430 may mean generating at least one signal for controlling the various operations of the detector 4300, but is not limited thereto.

In addition, the detector controller 4430 may include at least one of the following elements: a time counter 4431, a correction signal calculator 4432, a distance offset calculator 4433, and a distance calculator 4434.

Herein, the time counter 4431 may determine time on the basis of a signal acquired from the detector 4300.

For example, the time counter 4431 may determine a time point at which a signal acquired from the detector 4300 is equal to or greater than a threshold (threshold value), but is not limited thereto.

In addition, the correction signal calculator 4432 may calculate a correction signal on the basis of a signal acquired from the detector 4300.

For example, the correction signal calculator 4432 may calculate a correction signal on the basis of a difference between the width of a signal acquired from the detector 4300 and the width of a reference signal, and may use the correction signal to control a voltage applied to the detector 4300. However, no limitation thereto is imposed.

In addition, the distance offset calculator 4433 may calculate an offset distance on the basis of a signal acquired from the detector 4300.

For example, the distance offset calculator 4433 may calculate an offset distance on the basis of a time point at which a signal is acquired from the detector 4300 and reference distance information, but is not limited thereto.

In addition, the distance calculator 4434 may calculate a distance to an object on the basis of a signal acquired from the detector 4300.

For example, the distance calculator 4434 may calculate a distance to an object on the basis of a time point at which a trigger signal is generated from the laser output controller 4410 and a time point at which a signal is acquired from the detector 4300, but is not limited thereto.

In addition, for example, the distance calculator 4434 may calculate a distance to an object on the basis of a time point at which a trigger signal is generated from the laser output controller 4410, a time point at which a signal is acquired from the detector 4300, and an offset distance, but is not limited thereto.

In addition, the offset distance and the distance offset described above may be expressed as an offset time and a time offset. In a LiDAR device using a time value in order to calculate a distance to an object, calculating a final distance by using the offset distance and by using the offset time correspond to the same technical idea, so in the present specification and claims, descriptions using the terms “offset distance” and “offset time” may correspond to the same technical idea.

Hereinafter, the detailed operation of the correction signal calculator, the detailed operation of the distance offset calculator, and the detailed operation of the distance calculator will be described in more detail.

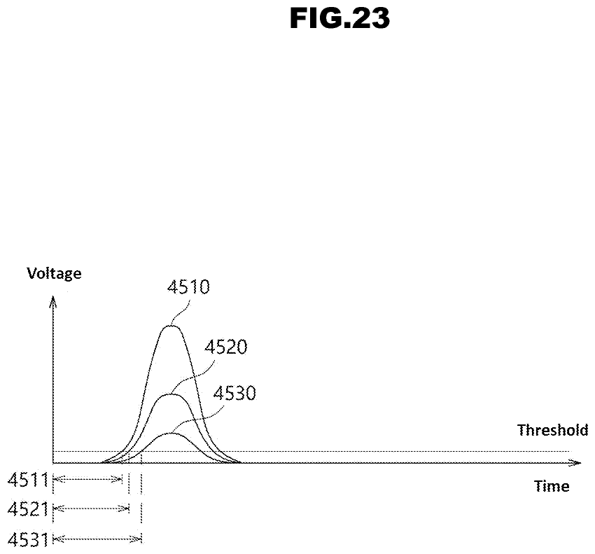

FIG. 23 is a diagram illustrating a correlation between a received signal gain and a measurement distance.

The gain of a received signal acquired from a detector included in a LiDAR device may be changed by various conditions.

For example, the gain of a received signal acquired from a detector included in a LiDAR device may be changed according to a distance to an item.

As a more specific example, the gain of a received signal acquired from a detector included in a LiDAR device may increase as a distance to an item decreases, or may decrease as the distance to the item increases.

In addition, for example, the gain of a received signal acquired from a detector included in a LiDAR device may be changed according to the reflectance of an item.

As a more specific example, the gain of a received signal acquired from a detector included in a LiDAR device may increase as the reflectance of an item increases, or may decrease as the reflectance of the item decreases.

In addition, for example, the gain of a received signal acquired from a detector included in a LiDAR device may be changed according to an operating condition of the detector.

As a more specific example, the gain of a received signal acquired from a detector included in a LiDAR device may be changed according to the temperature of the detector, but is not limited thereto.

In addition, for example, the gain of a received signal acquired from a detector included in a LiDAR device may be changed by a voltage applied to the detector.

As a more specific example, the gain of a received signal acquired from a detector included in a LiDAR device may increase as the voltage applied to the detector increases, or may decrease as the voltage applied to the detector decreases, but is not limited thereto.

FIG. 23 shows signals acquired with different gains for the same item as an example.

More specifically, FIG. 23 shows a first signal 4510 according to a first gain, a second signal 4520 according to a second gain, and a third signal 4530 according to a third gain.

Herein, since the first to the third signals 4510 to 4530 are signals for the same item, it is desirable that the same distance is measured. However, when an algorithm for finding a time point of generation of a signal by using one threshold is applied, different distances may be measured.

For example, when a distance is calculated by applying the threshold to the first signal 4510, the distance may be calculated on the basis of a first time value 4511. When a distance is calculated by applying the threshold to the second signal 4520, the distance may be calculated on the basis of a second time value 4521. When a distance is calculated by applying the threshold to the third signal 4530, the distance may be calculated on the basis of a third time value 4531.

Accordingly, as shown in FIG. 23, since the first to the third time value 4511, 4521, and 4531 are different from each other, distance values calculated on the basis of the first to the third time value 4511, 4521, and 4531 may be different from each other.

As a result, in order for a LiDAR device to measure a more accurate distance, it may be important to reduce a factor that changes a gain value of a received signal. It may allow a distance to be more exactly measured to maintain the gain of the received signal by adjusting a voltage applied to the detector according to the operating condition of the detector.

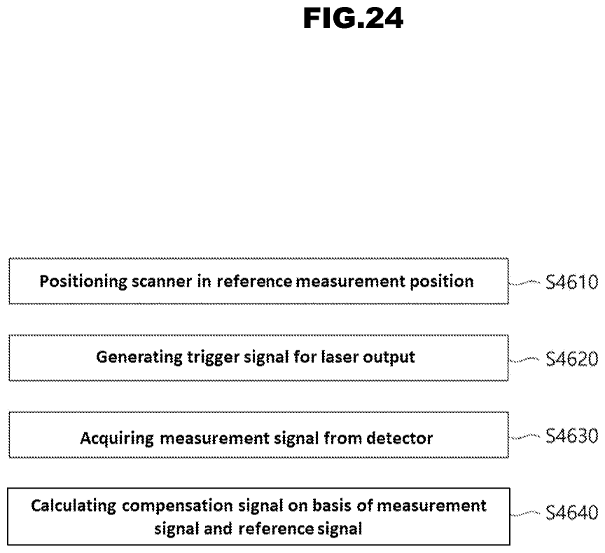

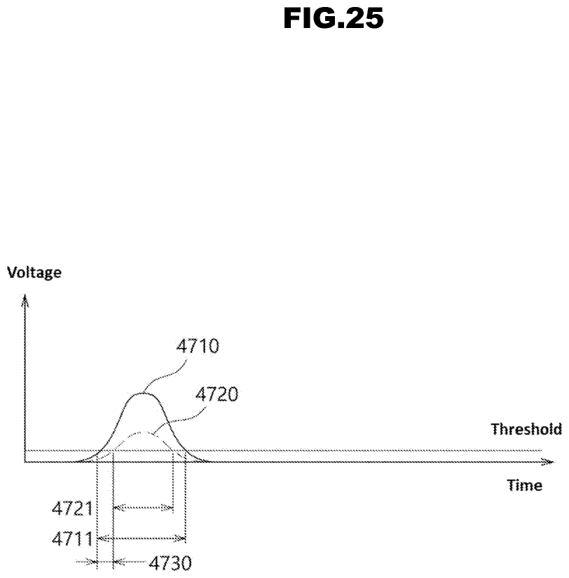

FIG. 24 is a flowchart illustrating a method of calculating a compensation signal according to an embodiment. FIG. 25 is a diagram illustrating a method of calculating a compensation signal according to an embodiment.

Referring to FIG. 24, a method of calculating a compensation signal according to an embodiment may include: positioning a scanner in a reference measurement position (S4610); generating a trigger signal for laser output (S4620); acquiring a measurement signal from a detector (S4630); and calculating the compensation signal on the basis of the measurement signal and a reference signal (S4640).

Herein, a method of calculating a compensation signal according to an embodiment may be realized by using a controller including at least one processor, but is not limited thereto.

The positioning the scanner in the reference measurement position (S4610) according to an embodiment may comprise both generating a control signal to position the scanner in the reference measurement position and positioning the scanner in the reference measurement position during rotation.

Herein, the reference measurement position may mean a position of the scanner at which a laser output from a laser emitter is reflected from the scanner and reaches the above-described fixed mirror, and the details of the above-described reference measurement position may be applied to the position.

The generating the trigger signal for laser output (S4620) according to an embodiment may be realized through the above-described laser output controller, but is not limited thereto.

In the acquiring the measurement signal from the detector (S4630) according to an embodiment, the measurement signal acquired from the detector may be a signal for a laser that is output from the laser emitter and reflected from the scanner and the fixed mirror and received by the detector.

In addition, the acquiring the measurement signal from the detector (S4630) according to an embodiment may comprise acquiring at least one measurement value for the measurement signal by using a threshold.

Herein, the at least one measurement value may include a time value of measurement of a rising edge of a signal, a time value of measurement of a falling edge of a signal, a width value of a signal, etc., but is not limited thereto.

The calculating the compensation signal on the basis of the measurement signal and the reference signal (S4640) according to an embodiment may comprise calculating the compensation signal on the basis of the width of the measurement signal and the width of the reference signal.

For example, the calculating the compensation signal on the basis of the measurement signal and the reference signal (S4640) according to an embodiment may comprise calculating the compensation signal on the basis of a difference value between the width of the measurement signal and the width of the reference signal, but is not limited thereto.

In addition, the calculating the compensation signal on the basis of the measurement signal and the reference signal (S4640) according to an embodiment may comprise calculating the compensation signal on the basis of the size of the measurement signal and the size of the reference signal.

For example, the calculating the compensation signal on the basis of the measurement signal and the reference signal (S4640) according to an embodiment may comprise calculating the compensation signal on the basis of a difference value between the size of the measurement signal and the size of the reference signal, but is not limited thereto.

In addition, when calculating the compensation signal on the basis of the measurement signal and the reference signal according to an embodiment, the reference signal may include a pre-acquired or stored signal, the width of the signal, the size of the signal, etc., but is not limited thereto.

In addition, the calculating the compensation signal on the basis of the measurement signal and the reference signal (S4640) according to an embodiment will be described in detail with reference to FIG. 25.

FIG. 25 shows a reference signal 4710 according to an embodiment and a measurement signal 4720 according to an embodiment.

Herein, a width 4711 of the reference signal 4710 stored or calculated on the basis of a preset threshold (threshold value) may be different from a width 4721 of the measurement signal 4720 computed or calculated on the basis of the preset threshold.

Accordingly, a controller may adjust a voltage applied to a detector so that the width 4721 of the measurement signal (or measured signal) 4720 is equal to the width 4711 of the reference signal 4710.

For example, the controller may calculate a compensation signal for adjusting a voltage applied to the detector, on the basis of a difference between the width 4721 of the measurement signal 4720 and the width 4711 of the reference signal 4710 so that the width 4721 of the measurement signal 4720 is equal to the width 4711 of the reference signal 4710.

For example, a calculation formula for calculating the compensation signal may be as follows.

Compensation value=α×(T_{PW}_{_{ref}}−T_{PW}_{ₘₑₐₛ})

Herein, T_{PW}_{_{ref}} may mean the width 4711 of the reference signal 4710, and T_{PW}_{ₘₑₐₛ} may mean the width 4721 of the measurement signal 4720.

Furthermore, a may be a coefficient value, and may be a value calculated on the basis of experimental data.

Furthermore, a may have a unit of volt/sec, but is not limited thereto.

In addition, for example, the controller may calculate a compensation signal for adjusting a voltage applied to the detector, on the basis of a time value 4730 to be compensated for so that the width 4721 of the measurement signal 4720 can be equal to the width 4711 of the reference signal 4710.

For example, a calculation formula for calculating the compensation signal may be as follows.

Compensation value=α×T_{PWC}

Herein, T_{PWC} may mean the time value 4730 to be compensated for, and the time value 4730 to be compensated for may be calculated on the basis of a difference between the width 4721 of the measurement signal 4720 and the width 4711 of the reference signal 4710.

For example, a calculation formula for calculating the time value 4730 to be compensated for may be as follows.

$${T}_{PWC} = \frac{1}{2} ( {T}_{{PW}_{ref}} - {T}_{{PW}_{meas}} )$$

Furthermore, a may be a coefficient value, and may be a value calculated on the basis of experimental data.

Furthermore, a may have a unit of volt/sec, but is not limited thereto.

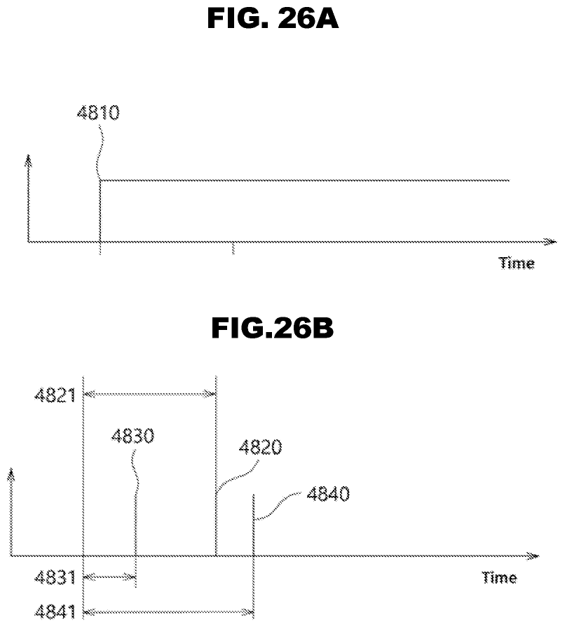

FIGS. 26A and 26B are diagrams illustrating a correlation between a laser output trigger signal and an actual laser output time point.

FIG. 26A is a diagram schematically illustrating a laser output trigger signal, and FIG. 26B is a diagram schematically illustrating a laser output time point according to operating conditions.

Referring to FIG. 26A, a laser output controller may generate a laser output trigger signal 4810 at a first time point.

Herein, after the laser output controller generates the laser output trigger signal 4810, a laser emitter may acquire the laser output trigger signal 4810, and then perform the operation for outputting a laser, and the laser emitter may output a laser after a particular delay from a time point of generation of the laser output trigger signal 4810 according to the configuration of the laser emitter. However, the particular delay may vary according to operating conditions of the laser emitter.

For example, referring to FIG. 26B, the laser emitter is in a first operating condition, a first laser 4820 may be output at a second time point. When the laser emitter is in a second operating condition, a second laser 4830 may be output at a third time point. When the laser emitter is in a third operating condition, a third laser 4840 may be output at a fourth time point.

Herein, the first to the third laser 4820, 4830, and 4840 are just described to explain a difference between laser output time points under assumed operating conditions. When the laser output trigger signal 4810 is generated, if the operating condition of the laser emitter is the first operating condition, the first laser 4820 is output at the second time point, or if the operating condition of the laser emitter is the second operating condition, the second laser 4830 is output at the third time point, or if the operating condition of the laser emitter is the third operating condition, the third laser 4840 is output at the fourth time point. However, no limitation thereto is imposed.

As shown in FIG. 26B, a time point at which a laser is output from a laser emitter may vary according to the operating conditions of the laser emitter.

More specifically, when the laser emitter is in the first operating condition, the first laser 4820 may be output at the second time point after a first time interval 4821 from the time point of generation of the laser output trigger signal 4810. When the laser emitter is in the second operating condition, the second laser 4830 may be output at the third time point after a second time interval 4831 from the time point of generation of the laser output trigger signal 4810. When the laser emitter is in the third operating condition, the third laser 4840 may be output at the fourth time point after a third time interval 4841 from the time point of generation of the laser output trigger signal 4810.

Herein, the first operating condition may be a reference operating condition and the second time point may be a laser output time point calculated or measured as a reference, but are not limited thereto.

As described above, in the case in which a laser output time point varies according to the operating conditions of the laser emitter, a distance error may occur when the LiDAR device calculates a distance to an object on the basis of a time point of generation of the laser output trigger signal 4810.

So, in the related art, in order to solve this, a method of dividing and measuring a part of a laser output has been considered so as to directly detect a time point of generation of laser output.

However, dividing a part of a laser output as in the related art may decrease scan efficiency.

Accordingly, a method of acquiring an offset distance (correction distance) for reducing an error according to the operating conditions of the laser emitter may be important.

Hereinafter, a method of acquiring an offset distance will be described in more detail.

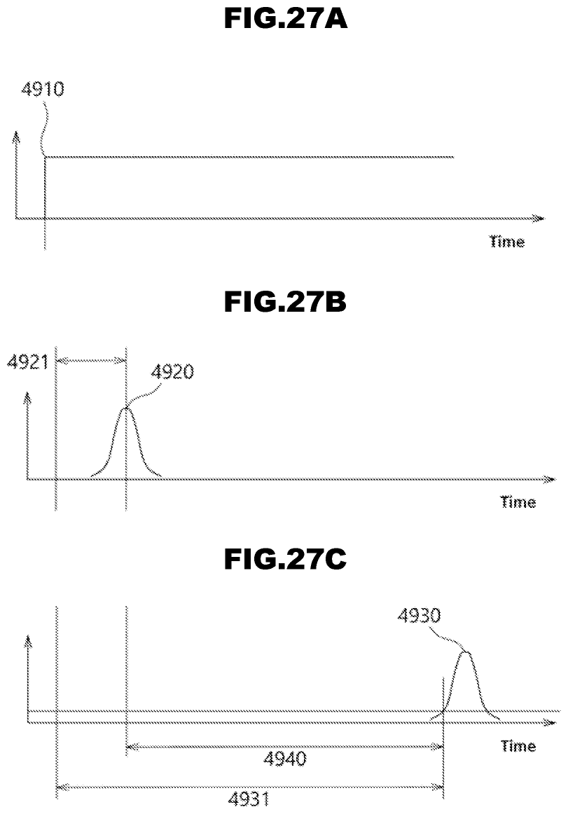

FIGS. 27A through 27C are diagrams illustrating the operation of a distance offset calculator according to an embodiment.

FIG. 27A is a diagram schematically illustrating a laser output trigger signal. FIG. 27B is a diagram schematically illustrating an output laser. FIG. 27C is a diagram schematically illustrating a signal acquired from a detector.

Referring to FIGS. 27A through 27C, a laser output controller may generate a laser output trigger signal 4910 at a first time point.

In addition, a laser 4920 may be output at a second time point after a first time interval 4921 from the first time point.

Herein, the first time interval 4921 may be changed according to the operating conditions of the laser emitter as described above.

In addition, the laser output from the laser emitter may be received along a preset light path by the detector.

Herein, the preset light path may mean a preset path from output of the laser from the laser emitter to reception by the detector.

For example, the preset light path may mean a light path along which a laser output from the laser emitter is reflected from the above-described scanner and reflected from the above-described fixed mirror and reflected again from the above-described scanner and received by the detector. However, the preset light path is not limited thereto, and may mean various paths pre-designed so that a laser output from the laser emitter is received by the detector.

In addition, after the laser 4920 is output from the laser emitter and a second time interval 4940 elapses, a signal 4930 for the laser 4920 may be acquired from the detector.

Herein, the second time interval 4940 may be a time interval corresponding to the preset light path.

For example, the second time interval 4940 may correspond to the time required for a laser to fly along the preset light path.

Therefore, the second time interval 4940 may correspond to a reference time interval, and the reference time interval may be a value calculated according to the designed preset light path or stored.

In addition, there is a third time interval 4931 between the time point of generation of the laser output trigger signal 4910 and the time point of acquisition of the signal 4930 by the detector.

Herein, the third time interval 4931 may correspond to a measured time interval.

For example, in the case in which in order to measure a distance to an object, a LiDAR device uses a time-of-flight (TOF) method using a time interval from a time point of generation of a laser output trigger signal to a time point of acquisition of a signal by a detection sensor, the third time interval 4931 may be a time interval measured for distance measurement.

As a result, referring to FIGS. 27A through 27C, for exact calculation of a distance, the second time interval 4940 corresponding to the preset light path should be used for the calculation, but a measured time interval may be the third time interval 4931, not the second time interval 4940.

Accordingly, an offset as much as the first time interval 4921 may be generated according to the operating conditions of the laser emitter. The distance offset calculator may calculate the first time interval 4921 corresponding to the offset time (distance) on the basis of the third time interval 4931 corresponding to the measured time interval and the second time interval 4940 corresponding to the reference time interval.

Thus, the distance offset calculator may calculate an offset time (distance) by using the following equation.

T_{offset}=Tₘₑₐₛ−T_{ref}

Herein, the T_{offset} may mean an offset time (distance), and may correspond to the first time interval 4921 according to the above description.

In addition, the Tₘₑₐₛ may mean a measured time interval, and may correspond to the third time interval 4931 according to the above description.

In addition, the T_{ref} may mean a reference time interval, and may correspond to the second time interval 4940 according to the above description.

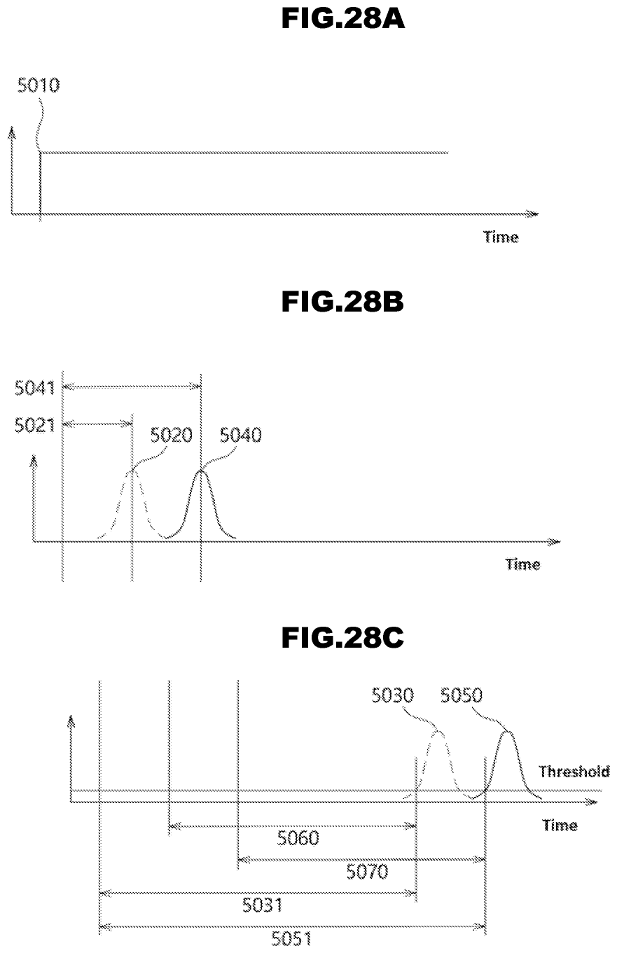

FIGS. 28A through 28C are diagrams illustrating the operation of a distance offset calculator according to an embodiment.

FIG. 28A is a diagram schematically illustrating a laser output trigger signal. FIG. 28B is a diagram schematically illustrating an output laser. FIG. 28C is a diagram schematically illustrating a signal acquired from a detector.

Herein, in FIGS. 28A through 28C, the pulses expressed in dotted lines may mean a first laser output when a laser emitter is in a first operating condition and a signal acquired from the detector for the first laser, and the pulses expressed in solid lines may mean a second laser output when the laser emitter is in a second operating condition and a signal acquired from a detection sensor for the second laser.

These will be described as a first laser 5020, a second laser 5040, a first detecting signal 5030, and a second detecting signal 5050.

The details described above with reference to FIGS. 27A through 27C may be applied to the details described with reference to FIGS. 28A through 28C, so a redundant description will be omitted.

Referring to FIGS. 28A through 28C, a laser output controller may generate a laser output trigger signal 5010 at a first time point.

In addition, when the laser emitter is in the first operating condition, the first laser 5020 may be output at a second time point after a first time interval 5021 from the first time point, and the first detecting signal 5030 for the first laser 5020 may be acquired by the detector at a third time point after the first laser 5020 is output and a second time interval 5060 elapses.

Herein, the first time interval 5021 may correspond to a first offset time (distance), and the second time interval 5060 may correspond to a reference time interval, and a third time interval 5031 may correspond to a first measured time interval.

In addition, when the laser emitter is in the second operating condition, the second laser 5040 may be output at a fourth time point after a fourth time interval 5041 from the first time point, and the second detecting signal 5050 for the second laser 5040 may be acquired by the detector at a fifth time point after the second laser 5040 is output and a fifth time interval 5070 elapses.

Herein, the fourth time interval 5041 may correspond to a second offset time (distance), and the fifth time interval 5070 may correspond to a reference time interval, and a sixth time interval 5051 may correspond to a second measured time interval.

Accordingly, referring to FIG. 28, an offset time (distance) may be changed according to the operating conditions of the laser emitter.

Thus, when the laser emitter operates under the first operating condition, the distance offset calculator may calculate an offset time (distance) by using the following equation.

T_{offset}=Tₘₑₐₛ₁−T_{ref}

Herein, the T_{offset} may mean a first offset time (distance), and may correspond to the first time interval 5021 according to the above description.

In addition, the Tₘₑₐₛ₁ may mean a first measured time interval, and may correspond to the third time interval 5031 according to the above description.

In addition, the T_{ref} may mean a reference time interval, and may correspond to the second time interval 5060 according to the above description.

In addition, when the laser emitter operates under the second operating condition, the distance offset calculator may calculate an offset time (distance) by using the following equation.

T_{offset2}=Tₘₑₐₛ₂−T_{ref}

Herein, the T_{offset2} may mean a second offset time (distance), and may correspond to the fourth time interval 5041 according to the above description.

In addition, the Tₘₑₐₛ₂ may mean a first measured time interval, and may mean the sixth time interval 5051 according to the above description.

In addition, the T_{ref} may mean a reference time interval, and may correspond to the fifth time interval 5070 according to the above description.

In addition, the operating conditions of the laser emitter may include a surrounding environment, such as the temperature of the laser emitter, etc. Therefore, the operating conditions of the laser emitter may be changed according to the driving of the LiDAR device.

Therefore, the operation of the distance offset calculator as described above is performed in real time or periodically, and when an offset time (distance) suitable for an operating condition of the laser emitter is calculated, an accurate distance may be continuously measured.

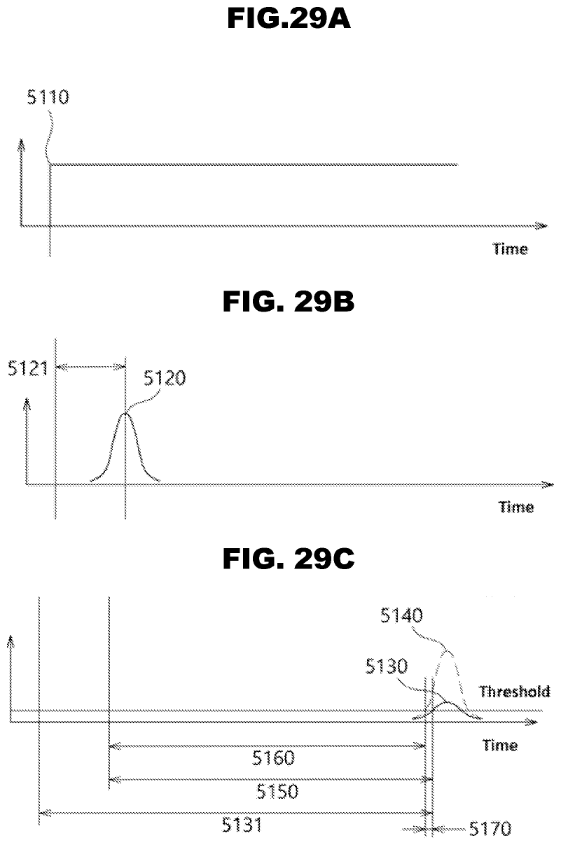

FIGS. 29A through 29C are diagrams illustrating the operation of a distance offset calculator according to an embodiment.

FIG. 29A is a diagram schematically illustrating a laser output trigger signal. FIG. 29B is a diagram schematically illustrating an output laser. FIG. 29C is a diagram schematically illustrating a signal acquired from a detector.

Herein, the pulse expressed in a dotted line in FIG. 29C may mean a signal having a reference reception gain, and the pulse expressed in a solid line may mean a signal actually acquired from the detector.

The details described above with reference to FIG. 27A through FIG. 28C may be applied to the details described with reference to FIGS. 29A through 29C, so a redundant description will be omitted.

FIGS. 29A through 29C, a laser output controller may generate a laser output trigger signal 5110 at a first time point, and a laser 5120 may be output at a second time point after a first time interval 5121 from the first time point, and a detecting signal 5130 for the laser 5120 may be acquired from the detector at a third time point after the laser 5120 is output and a second time interval 5150 elapses.

Herein, the second time interval 5150 may be different from a reference time interval 5160.

For example, the reference time interval 5160 may be a time interval when a reference detecting signal 5140 is acquired from the detector after the laser 5120 is output. When the detecting signal 5130 different from the reference detecting signal 5140 is acquired from the detector, the second time interval 5150 may be different from the reference time interval 5160.

Accordingly, when the operation of a compensation signal calculator described above with reference to FIGS. 23 to 25 is applied in order to maintain the reception gain of the detector, compensation for as much as a fourth time interval 5170 is performed twice and an error may occur, wherein the fourth time interval 5170 is the difference between the second time interval 5150 and the reference time interval 5160.

Thus, the distance offset calculator may calculate an offset time (distance) by using the following equation.

T_{offset}=Tₘₑₐₛ−T_{ref}−T_{pwc}

Herein, the T_{offset} may mean an offset time (distance), and may correspond to the first time interval 5121 according to the above description.

In addition, the Tₘₑₐₛ may mean a measured time interval, and may correspond to the third time interval 5131 according to the above description.

In addition, the T_{ref} may mean a reference time interval, and may correspond to the reference time interval 5160 according to the above description.

In addition, the T_{pwc} may mean a time value to be compensated for, and may correspond to the fourth time interval 5170 according to the above description.

In addition, the sum of the T_{ref} and the T_{pwc} may correspond to the second time interval 5150 according to the above description.

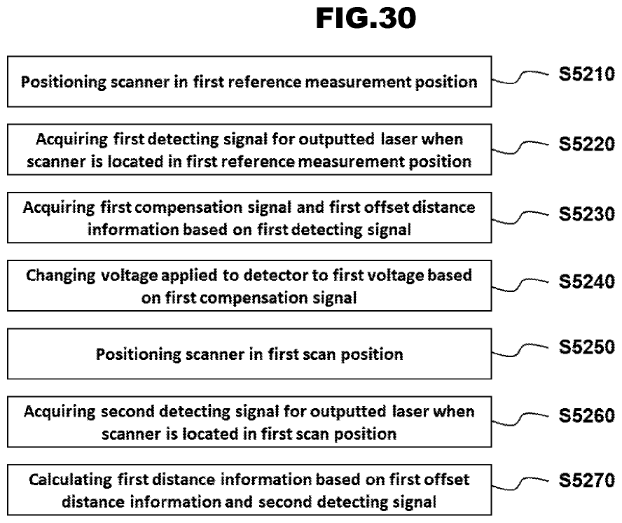

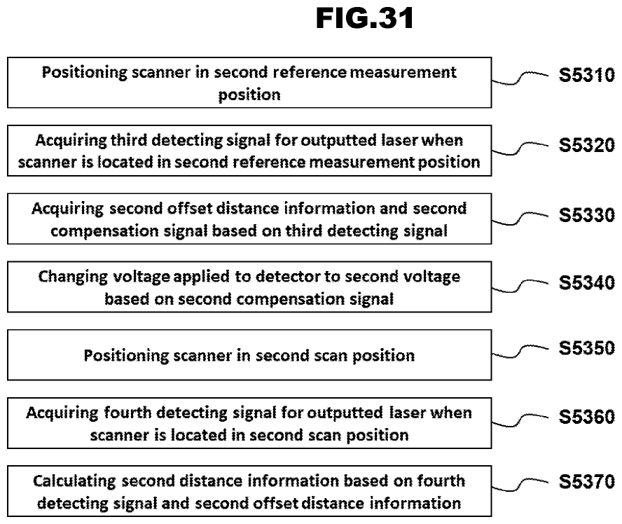

FIGS. 30 and 31 are flowcharts illustrating a method for operating a LiDAR device according to an embodiment.

Referring to FIGS. 30 and 31, a method for operating a LiDAR device according to an embodiment may comprise at least part of the following: positioning a scanner in a first reference measurement position (S5210); acquiring a first detecting signal for an outputted laser when the scanner is located in the first reference measurement position (S5220); acquiring a first compensation signal and first offset distance information based on the first detecting signal (S5230); changing a voltage applied to a detector to a first voltage based on the first compensation signal (S5240); positioning the scanner in a first scan position (S5250); acquiring a second detecting signal for the outputted laser when the scanner is located in the first scan position (S5260); calculating first distance information based on the first offset distance information and the second detecting signal (S5270); positioning the scanner in a second reference measurement position (S5310); acquiring a third detecting signal for the outputted laser when the scanner is located in the second reference measurement position (S5320); acquiring second offset distance information and a second compensation signal based on the third detecting signal (S5330); changing the voltage applied to the detector to a second voltage based on the second compensation signal (S5340); positioning the scanner in the second scan position (S5350); acquiring a fourth detecting signal for the outputted laser when the scanner is located in the second scan position (S5360); and calculating the second distance information based on the fourth detecting signal and the second offset distance information (S5370).

Herein, a method for operating a LiDAR device according to an embodiment may be realized by using a controller including at least one processor, but is not limited thereto.

The positioning the scanner in the first reference measurement position (S5210) according to an embodiment may be realized by the above-described scan controller, but is not limited thereto.

In addition, the positioning the scanner in the first reference measurement position (S5210) according to an embodiment may include both generating a control signal to position the scanner in the first reference measurement position and positioning the scanner in the first reference measurement position during rotation.

Herein, the first reference measurement position may mean at least one of the positions of the scanner in which a laser output from a laser emitter is received by the detector along a preset reference light path, but is not limited thereto.

In addition, the acquiring the first detecting signal for the outputted laser when the scanner is located in the first reference measurement position (S5220) according to an embodiment may be realized by the above-described detector controller, but is not limited thereto.

Herein, the first detecting signal may be a signal for a laser that is output from the laser emitter and reflected from the scanner and a fixed mirror and received by the detector, but is not limited thereto.

In addition, the acquiring the first detecting signal for the outputted laser when the scanner is located in the first reference measurement position (S5220) according to an embodiment may include acquiring at least one measurement value for the first detecting signal by using a threshold.

Herein, the at least one measurement value may include a time value of measurement of a rising edge of a signal, a time value of measurement of a falling edge of a signal, a width value of a signal, etc., but is not limited thereto.

In addition, the acquiring the first compensation signal and the first offset distance information based on the first detecting signal (S5230) according to an embodiment may be realized by the above-described detector controller, but is not limited thereto.

In addition, the details described above with reference to FIGS. 23 to 29 may be applied to the acquiring the first compensation signal and the first offset distance information based on the first detecting signal (S5230) according to an embodiment, so a redundant description will be omitted.

In addition, the changing the voltage applied to the detector to the first voltage based on the first compensation signal (S5240) according to an embodiment may be realized by the above-described detector controller, but is not limited thereto.

In addition, the details described above with reference to FIGS. 23 to 25 may be applied to the changing the voltage applied to the detector to the first voltage based on the first compensation signal (S5240) according to an embodiment, so a redundant description will be omitted.

In addition, the positioning the scanner in the first scan position (S5250) according to an embodiment may be realized by the above-described scan controller, but is not limited thereto.

In addition, the positioning the scanner in the first scan position (S5250) according to an embodiment may comprise both generating a control signal to position the scanner in the first scan position and positioning the scanner in the first scan position during rotation.

Herein, the first scan position may mean at least one of the positions of the scanner in which a laser output from the laser emitter is emitted to the outside of the LiDAR device, but is not limited thereto.

In addition, the acquiring the second detecting signal for the outputted laser when the scanner is located in the first scan position (S5260) according to an embodiment may be realized by the above-described detector controller, but is not limited thereto.

Herein, the second detecting signal may be a signal for a laser that is output from the laser emitter and reflected from an object outside the LiDAR device and received by the detector, but is not limited thereto.

In addition, the acquiring the second detecting signal for the outputted laser when the scanner is located in the first scan position (S5260) according to an embodiment may comprise acquiring at least one measurement value for the second detecting signal by using the threshold.

Herein, the at least one measurement value may include a time value of measurement of a rising edge of a signal, a time value of measurement of a falling edge of a signal, a width value of a signal, etc., but is not limited thereto.

In addition, the calculating the first distance information based on the first offset distance information and the second detecting signal (S5270) according to an embodiment may be realized by the above-described detector controller, but is not limited thereto.

In addition, in the calculating the first distance information based on the first offset distance information and the second detecting signal (S5270) according to an embodiment, a difference between a time point of detection of the second detecting signal and a first offset time corresponding to the first offset distance may be used to calculate the first distance information.

More specifically, the following equations may be used to calculate the first distance information.

$${d}_{{obj}_{meas}} - {d}_{offset}$$

$${d}_{obj} = \frac{1}{2} \times C \times ( {T}_{{obj}_{meas}} - {T}_{offset} )$$

Herein, the d_{obj} may mean a distance to an object, and may correspond to the first distance information according to the above description.

In addition, the d_{obj}_{ₘₑₐₛ} may mean a distance calculated on the basis of a detecting signal, and may mean a distance calculated on the basis of the second detecting signal according to the above description.

In addition, the d_{offset} may mean an offset distance, and may correspond to a first offset distance according to the above description.

In addition, the T_{obj}_{ₘₑₐₛ} may correspond to a time point at which a detecting signal is detected, and may correspond to the time point at which the second detecting signal is detected according to the above description.

In addition, the T_{offset} may mean an offset time, and may correspond to a first offset time according to the above description.

In addition, the positioning the scanner in the second reference measurement position (S5310) according to an embodiment may be realized by the above-described scan controller, but is not limited thereto.

In addition, the positioning the scanner in the second reference measurement position (S5310 according to an embodiment may include both generating a control signal to position the scanner in the second reference measurement position and positioning the scanner in the second reference measurement position during rotation.

Herein, the second reference measurement position may mean at least one of the positions of the scanner in which a laser output from the laser emitter is received by the detector along the preset reference light path, but is not limited thereto.

In addition, the acquiring the third detecting signal for the outputted laser when the scanner is located in the second reference measurement position (S5320) according to an embodiment may be realized by the above-described detector controller, but is not limited thereto.

Herein, the third detecting signal may be a signal for a laser that is output from the laser emitter and reflected from the scanner and the fixed mirror and received by the detector, but is not limited thereto.

In addition, the acquiring the third detecting signal for the outputted laser when the scanner is located in the second reference measurement position (S5320) according to an embodiment may comprise acquiring at least one measurement value for the third detecting signal by using the threshold.

Herein, the at least one measurement value may include a time value of measurement of a rising edge of a signal, a time value of measurement of a falling edge of a signal, a width value of a signal, etc., but is not limited thereto.

In addition, the acquiring the second offset distance information and the second compensation signal based on the third detecting signal (S5330) according to an embodiment may be realized by the above-described detector controller, but is not limited thereto.

In addition, the details described above with reference to FIGS. 23 to 29 may be applied to the acquiring the second offset distance information and the second compensation signal based on the third detecting signal (S5330) according to an embodiment, so a redundant description will be omitted.

In addition, the changing the voltage applied to the detector to the second voltage based on the second compensation signal (S5340) according to an embodiment may be realized by the above-described detector controller, but is not limited thereto.

In addition, the details described above with reference to FIGS. 23 to 25 may be applied to the changing the voltage applied to the detector to the second voltage based on the second compensation signal (S5340) according to an embodiment, so a redundant description will be omitted.

In addition, the positioning the scanner in the second scan position (S5350) according to an embodiment may be realized by the above-described scan controller, but is not limited thereto.

In addition, the positioning the scanner in the second scan position (S5350) according to an embodiment may include both generating a control signal to position the scanner in the second scan position and positioning the scanner in the second scan position during rotation.

Herein, the second scan position may mean at least one of the positions of the scanner in which a laser output from the laser emitter is emitted to the outside of the LiDAR device, but is not limited thereto.

In addition, the acquiring the fourth detecting signal for the outputted laser when the scanner is located in the second scan position (S5360) according to an embodiment may be realized by the above-described detector controller, but is not limited thereto.

Herein, the fourth detecting signal may be a signal for a laser that is output from the laser emitter and reflected from an object outside the LiDAR device and received by the detector, but is not limited thereto.

In addition, the acquiring the fourth detecting signal for the outputted laser when the scanner is located in the second scan position (S5360) according to an embodiment may comprise acquiring at least one measurement value for the fourth detecting signal by using the threshold.

Herein, the at least one measurement value may include a time value of measurement of a rising edge of a signal, a time value of measurement of a falling edge of a signal, a width value of a signal, etc., but is not limited thereto.

In addition, the calculating the second distance information based on the fourth detecting signal and the second offset distance information (S5370) according to an embodiment may be realized by the above-described detector controller, but is not limited thereto.

In addition, in the calculating the second distance information based on the fourth detecting signal and the second offset distance information (S5370) according to an embodiment, a difference between a time point of detection of the fourth detecting signal and a second offset time corresponding to the second offset distance may be used to calculate the second distance information.

More specifically, the following equations may be used to calculate the second distance information.

$${d}_{{obj}_{meas}} - {d}_{offset}$$

$${d}_{obj} = \frac{1}{2} \times C \times ( {T}_{{obj}_{meas}} - {T}_{offset} )$$

Herein, the d_{obj} may mean a distance to an object, and may correspond to the second distance information according to the above description.

In addition, the d_{obj}_{ₘₑₐₛ} may mean a distance calculated on the basis of a detecting signal, and may mean a distance calculated on the basis of the fourth detecting signal according to the above description.

In addition, the d_{offset} may mean an offset distance, and may correspond to a second offset distance according to the above description.

In addition, the T_{obj}_{ₘₑₐₛ} may correspond to a time point at which a detecting signal is detected, and may correspond to the time point at which the fourth detecting signal is detected according to the above description.

In addition, the T_{offset} may mean an offset time, and may correspond to a second offset time according to the above description.

In addition, the first reference measurement position may be identical to the second reference measurement position.

In addition, the first reference measurement position and the second reference measurement position may be different from each other.

In addition, the first scan position may be identical to the second scan position.

In addition, the first scan position and the second scan position may be different from each other.

In addition, the first voltage may be identical to the second voltage.

In addition, the first voltage and the second voltage may be different from each other.

In addition, the first offset distance information may be identical to the second offset distance information.

In addition, the first offset distance information and the second offset distance information may be different from each other.

In addition, when the first scan position is identical to the second scan position and the first offset distance information is different from the second offset distance information, the time point at which the second detecting signal is detected may be different from the time point at which the fourth detecting signal is detected.

In addition, when the first scan position is identical to the second scan position and the first offset distance information is identical to the second offset distance information, the time point at which the second detecting signal is detected may be identical to the time point at which the fourth detecting signal is detected.

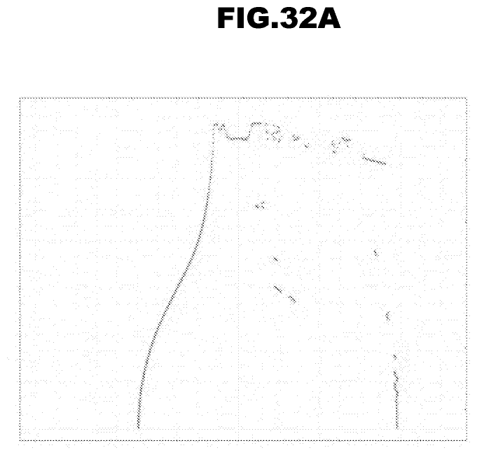

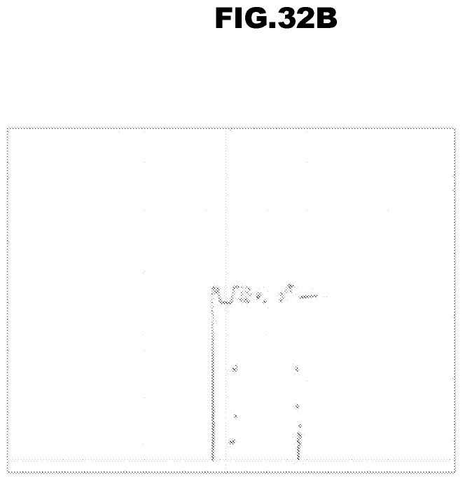

FIGS. 32A and 32B are diagrams illustrating comparison between measurement results according to an embodiment.

FIG. 32A is a diagram illustrating a measurement result when a correction signal calculator and a distance offset calculator according to the present disclosure did not operate. FIG. 32B is a diagram illustrating a measurement result when the correction signal calculator and the distance offset calculator according to the present disclosure operated.

In addition, FIGS. 32A and 32B are diagrams illustrating the results measured in an environment with a wall in a straight line to the left.

Referring to FIGS. 32A and 32B, it is found that when the correction signal calculator and the distance offset calculator according to the present disclosure did not operate, there was a large error in a distance to the wall in the straight line to the left. However, it is found that when the correction signal calculator and the distance offset calculator according to the present disclosure operated, an error in the distance to the wall in the straight line to the left was significantly reduced.

Accordingly, when the operations of the LiDAR device described above in the present specification are applied, it is possible to reduce a distance error caused by a change in operating conditions of the LiDAR device, thereby measuring a distance effectively and more accurately.

Methods according to the embodiments may be embodied as program commands executable by various computer means and may be recorded on a computer-readable recording medium. The computer-readable recording medium may include program commands, data files, data structures, and the like separately or in combinations. The program commands to be recorded on the computer-readable recording medium may be specially designed and configured for the embodiments may be well-known to and be usable by those skilled in the art of computer software. Examples of the computer-readable recording medium include magnetic recording media such as hard disks, floppy disks and magnetic tapes; optical data storage media such as CD-ROMs or DVD-ROMs; magneto-optical media such as floptical disks; and hardware devices, such as read-only memory (ROM), random-access memory (RAM), and flash memory, which are particularly structured to store and implement the program instruction. Examples of the program instructions include not only a mechanical language code formatted by a compiler but also a high level language code that may be implemented by a computer using an interpreter, and the like. The hardware devices may be configured to be operated by one or more software modules or vice versa to conduct the operation according to the embodiments.

Although the embodiments have been described with reference to the limited embodiments and drawings, it will be understood by those skilled in the art that various modifications and variations may be made from the description. For example, suitable results may be achieved if the described techniques are performed in an order different from the described method, and/or the elements of the above-described system, structure, device, and circuit are coupled or combined in a form different from the described method, or replaced or substituted by other elements or equivalents.

Therefore, other implementations, other embodiments, and equivalents to the claims are also within the scope of the following claims.

What is claimed is:

1. A Light Detecting and Ranging (LiDAR) device for measuring distance using a laser comprising:
a laser emitter configured to output the laser;
a scanner configured to rotate around an axis of rotation, and be located at a reference measurement position and a scan position;
a detector configured to detect the laser; and
a controller configured to control the laser emitter and the detector,
wherein the controller comprises:
a laser output controller configured to generate a trigger signal for controlling the laser emitter; and
a detector controller configured to process a signal acquired from the detector and control the detector,
wherein the detector controller comprises:
a correction signal calculator configured to calculate a correction signal to control a voltage applied to the detector;
a distance offset calculator configured to calculate a distance offset; and
a distance calculator configured to calculate a distance from an object;
wherein the correction signal calculator is configured to calculate the correction signal based on a first detecting signal acquired from the detector and outputted from the laser emitter and a reference signal when the scanner locates on the reference measurement position,
wherein the distance offset calculator is configured to calculate offset information based on the first detecting signal acquired from the detector and outputted from the laser emitter and reference information when the scanner locates on the reference measurement position,
wherein the distance calculator is configured to calculate the distance from the object based on a second detecting signal acquired in the detector and output from the laser emitter and the offset information when the scanner locates on the scan position.

2. The LiDAR device of claim 1, wherein the correction signal calculator is configured to calculate the correction signal based on a difference between a width of the first detecting signal and a width of the reference signal acquired from the detector.

3. The LiDAR device of claim 2, wherein the correction signal calculator is configured to calculate the correction signal based on a half of the difference between the width of the first detecting signal and the width of the reference signal acquired from the detector.

4. The LiDAR device of claim 1, wherein the distance offset calculator is configured to calculate the offset information based on a reference time interval which the reference information comprises and a time point of detection of the first detecting signal acquired from the detector.

5. The LiDAR device of claim 4, wherein the time point of detection of the first detecting signal acquired from the detector is obtained using a preset threshold and the signal acquired from the detector.

6. The LiDAR device of claim 4, wherein the reference time interval is a pre-stored time interval based on a reference light path.

7. The LiDAR device of claim 4, wherein the offset information includes at least one of the offset distance and the offset time.

8. The LiDAR device of claim 1, wherein the distance calculator is configured to calculate the distance from the object based on the offset information and the time point of detection of the second detecting signal and the time point of generation of the trigger signal.

9. The LiDAR device of claim 8, wherein the distance calculator is configured to calculate the distance from the object by correcting the time interval between the time point of detection of the second detecting signal and the time point of generation of the trigger signal using the offset information.

10. A method for operating a Light Detecting and Ranging (LiDAR) device for measuring distance using the laser, comprising:
positioning a scanner in a first reference measurement position;
acquiring a first detecting signal for an outputted laser when the scanner is located on the first reference measurement position;
acquiring a first compensation signal and first offset information based on the first detecting signal;
changing a voltage applied to the detector to a first voltage based on the first compensation signal;
positioning the scanner in a first scan position;
acquiring a second detecting signal for the outputted laser when the scanner is located on the first scan position;
acquiring first distance information based on first offset information and the second detecting signal;
positioning the scanner in a second reference measurement position;
acquiring a third detecting signal for the outputted laser when the scanner is located on the second reference measurement position;
acquiring second offset information and a second compensation signal based on the third detecting signal;
changing the voltage applied to the detector to a second voltage based on the second compensation signal;
positioning the scanner in the second scan position;
acquiring a fourth detecting signal for the outputted laser when the scanner is located on the second scan position; and
acquiring the second distance information based on the fourth detecting signal and the second offset information.

11. The method for operating LiDAR device of claim 10, wherein the first reference measurement position is identical to the second reference measurement position.

12. The method for operating LiDAR device of claim 10,
wherein when the first scan position is identical to the second scan position and the first offset information is different from the second offset information, a time point of detection of the second detecting signal and a time point of detection of the fourth detecting signal are not same.

13. The method for operating LiDAR device of claim 10,
wherein the first compensation signal is acquired based on a width of a pre-stored reference signal and a width of the first detecting signal,
and the second compensation signal is acquired based on the width of the pre-stored reference signal and a width of the third detecting signal.

14. The method for operating LiDAR device of claim 13,
wherein the first compensation signal is acquired based on a difference between the width of the pre-stored reference signal and the width of the first detecting signal,
and the second compensation signal is acquired based on a difference between the width of pre-stored reference signal and the width of the third detecting signal.

15. The method for operating LiDAR device of claim 10,
wherein the first distance information is acquired based on a difference between a width of a pre-stored reference signal and a width of the first detecting signal, the first offset information and the second detecting signal.

16. The method for operating LiDAR device of claim 15,
wherein the second distance information is acquired based on a difference between the width of the pre-stored reference signal and the width of the third detecting signal, the second offset information and the fourth detecting signal.
